(19) United States
(12) Patent Application Publication
(10) Pub. No.: US 2026/0162009 A1
(43) Pub. Date: Jun. 11, 2026

(54) BENCHMARKING AND MODIFYING BEHAVIORAL ROBUSTNESS OF TEXT-TO-SQL MODELS

(71) Applicant: Oracle International Corporation, Redwood Shores, CA (US)

(72) Inventors: Varsha Kuppur Rajendra, Bellevue, WA (US); Duy Vu, Melbourne (AU); Gioacchino Tangari, Sydney (AU); Dalu Guo, Sydney (AU); Steve Wai-Chun Siu, Melbourne (AU); Cong Duy Vu Hoang, Wantirna South (AU); Yakupitiyage Don Thanuja Samodhye Dharmasiri, Melbourne (AU); Thanh Long Duong, Melbourne (AU)

(73) Assignee: Oracle International Corporation, Redwood Shores, CA (US)

(21) Appl. No.: 19/301,535

(22) Filed: Aug. 15, 2025

Related U.S. Application Data
(60) Provisional application No. 63/729,250, filed on Dec. 6, 2024.

(51) Int. Cl. G06N 20/00; G06F 16/242

(52) U.S. Cl. CPC G06N 20/00; G06F 16/243

(57) ABSTRACT

Techniques are disclosed herein towards a process for enhancing generative model robustness. The process includes accessing a training data set comprising examples, each with a natural language utterance and a database schema. Each example is augmented by generating augmentation prompts with perturbation instructions, which direct the generative model to modify the prompt using one or more categories of perturbations. These perturbations may alter the natural language utterance, the database schema, or both, resulting in variant prompts. The augmented examples are added to an augmented training data set. Using these augmented training examples, a pre-trained generative model is fine-tuned, yielding a fine-tuned generative model capable of accurately and consistently producing structured queries in response to diverse natural language inputs and schema configurations.

### CROSS-REFERENCE TO RELATED APPLICATION

The present application is a non-provisional application of and claims the benefit and priority under 35 U.S.C. 119(e) of U.S. Provisional Application No. 63/729,250, filed on Dec. 6, 2024, the entire contents of which is incorporated herein by reference in its entirety for all purposes.

### FIELD

The present disclosure relates generally to converting natural language to a logical form, and more particularly, for improving robustness of generative models to semantically equivalent utterances.

### BACKGROUND

Conventional generative models have been adopted to assist users in translating natural language queries into specialized languages (e.g., SQL). This capability is useful for individuals lacking expertise in a target language as it enables the individual to interact with complex databases or systems using everyday language. By parsing the individual's request and generating a corresponding query, the generative models can bridge the knowledge gap allowing individuals to access or manipulate data without needing to understand an underlying syntax or structure of the target language.

Conventional generative models often struggle with producing consistent outputs when individuals phrase their requests differently, even if the underlying intent remains unchanged. For example, if a user first submits the query “retrieve revenue for this quarter,” and later phrases a similar request as “for this quarter, retrieve revenue,” the generative model might generate structurally different SQL queries, potentially resulting in inconsistent or unexpected data retrieval when applied to a database. The challenge becomes even more pronounced when the request is elaborated further, as in “Retrieve the revenue for the last quarter. I do not want to see pre-tax revenue.” Despite the semantic similarity, conventional generative models may misinterpret or inconsistently handle such queries, especially when dealing with negations or additional qualifying information. This inconsistency stems from the generative models' reliance on surface-level patterns and a limited ability to consistently capture and map the true semantic intent behind varied phrasings

These technical limitations lead to inefficiencies and operational challenges. For example, individuals must often rephrase or clarify requests multiple times which can be time-consuming and frustrating. Moreover, the lack of consistent query generation undermines reliability as similar requests could yield different results or need additional validation and correction by the user. The root of these difficulties lies in the generative models' inability to generalize across diverse linguistic expressions with adequate precision, particularly when subtle (or not subtle) changes in phrasing or context occur.

### BRIEF SUMMARY

Prompt engineering and generative model techniques are disclosed herein (e.g., a computer implemented method, a system, non-transitory computer-readable medium storing code or instructions executable by one or more processors) for improving robustness of generative models to semantically equivalent utterances.

In various embodiments, a computer-implemented method is provided, comprising accessing a training data set that includes training examples, where each training example comprises a prompt containing a natural language utterance and a database schema. Each of the training examples is augmented one or more times. Augmenting includes generating an augmentation prompt that contains a perturbation instruction, which instructs a generative model to modify the prompt of a training example in accordance with one or more perturbations selected from a set of categories of perturbations. The generative model generates an augmented training example based on the augmentation prompt and the training example, where generating the augmented training example comprises perturbing the natural language utterance, the database schema, or both, in accordance with the selected perturbations, such that the perturbing results in a variant prompt that is a variant of the natural language utterance, the database schema, or both. The augmented training example, which comprises the variant prompt, is then added to an augmented training data set. Thereafter, a pre-trained generative model is fine-tuned, based on the augmented training examples from the augmented training data set, in order to generate a fine-tuned generative model.

In various embodiments, the computer-implemented method further comprises accessing a test data set that includes test examples, where each test example comprises a prompt containing a natural language utterance and a database schema. Each of the test examples is augmented one or more times, wherein augmenting includes generating an augmentation prompt with a perturbation instruction, which instructs the generative model to modify the prompt of a test example in accordance with one or more perturbations selected from a set of categories of perturbations. The generative model then generates an augmented test example based on the augmentation prompt and the test example, where generating the augmented test example comprises perturbing the natural language utterance, the database schema, or both, of the prompt of the test example, in accordance with the selected perturbations, and where the perturbing generates a variant prompt comprising a variant of the natural language utterance, the database schema, or both. The augmented test example, which includes the variant prompt, is added to an augmented test data set. The performance of the fine-tuned generative model is then evaluated based on the augmented test examples from the augmented test data set.

In various embodiments, the computer-implemented method further comprises accessing an original set of training data for the pre-trained generative model, wherein the pre-trained generative model is fine-tuned based on batch balancing examples from the original set of training data and the augmented training examples from the augmented training data set.

In various embodiments, the computer-implemented method further comprises filtering the augmented training examples from the augmented training data set to obtain a filtered augmented training data set comprising filtered augmented training examples, wherein the filtering removes invalid augmented training examples from the augmented training data set, and wherein the pre-trained generative model is fine-tuned based on the filtered augmented training examples from the filtered augmented training data set to generate the fine-tuned generative model.

In various embodiments, the one or more perturbations comprise a paraphrase perturbation, a change in order perturbation, a punctuation perturbation, a change in length perturbation, a direct form change perturbation, a keyword replacement perturbation, or any combination thereof.

In various embodiments, the computer-implemented method further comprises receiving a natural language utterance from a user, generating, by the fine-tuned generative model, a programming language instruction based on the natural language utterance, executing the programming language instruction on a datastore to obtain a result, and providing the result to the user.

In various embodiments, the pre-trained generative model is pre-trained for a task of translating natural language utterances to structured query language instructions.

Some embodiments include a system that includes one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

The present disclosure will be better understood in view of the following non-limiting figures, in which:

FIG. 1 depicts a simplified diagram for an example NL2SQL tool, according to various embodiments.

FIG. 2 depicts a simplified diagram for an example generative AI SQL agent system, according to various embodiments.

FIG. 3 depicts a simplified diagram for an example generative AI SQL agent, according to various embodiments.

FIG. 4 depicts a simplified block diagram for training, testing, and producing an NL2SQL Model, according to various embodiments.

FIG. 5 depicts a simplified diagram for an example NL2LF process with different inputs resulting in different outputs, according to various embodiments.

FIG. 6 depicts a simplified block diagram for an example generative model fine-tuning process, according to various embodiments.

FIG. 7 depicts an example of paraphrasing perturbations, according to various embodiments.

FIG. 8 depicts an example of change in order perturbations, according to various embodiments.

FIG. 9 depicts an example of punctuation perturbations, according to various embodiments.

FIG. 10 depicts an example of change in length perturbations, according to various embodiments.

FIG. 11 depicts a an example of change in a type of direct form perturbations, according to various embodiments.

FIG. 12 depicts an example of keyword replacement perturbations, according to various embodiments.

FIG. 13 depicts an example of negation perturbations, according to various embodiments.

FIG. 14 depicts an example of subset selection perturbations, according to various embodiments.

FIG. 15 depicts a simplified diagram for an example NL2LF process with different inputs resulting in similar outputs, according to various embodiments.

FIG. 16 depicts a simplified flow diagram for an example generative model fine-tuning process, according to various embodiments.

FIG. 17 is a block diagram illustrating one pattern for implementing a cloud infrastructure as a service system, according to at least one embodiment.

FIG. 18 is a block diagram illustrating another pattern for implementing a cloud infrastructure as a service system, according to at least one embodiment.

FIG. 19 is a block diagram illustrating another pattern for implementing a cloud infrastructure as a service system, according to at least one embodiment.

FIG. 20 is a block diagram illustrating another pattern for implementing a cloud infrastructure as a service system, according to at least one embodiment.

FIG. 21 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### I. INTRODUCTION

In recent years, the amount of data powering different industries and their systems has been increasing exponentially. A majority of business information is stored in the form of relational databases that store, process, and retrieve data. Databases power information systems across multiple industries, for instance, consumer tech (e.g., orders, cancellations, refunds), supply chain (e.g., raw materials, stocks, vendors), healthcare (e.g., medical records), finance (e.g., financial business metrics), customer support, search engines, and much more. It is imperative for modern data-driven companies to track the real-time state of its business in order to quickly understand and diagnose any emerging issues, trends, or anomalies in the data and take immediate corrective actions. This work is usually performed manually by analysts who compose complex queries in query languages (e.g., database query languages such as declarative query languages) like SQL, PGQL, logical database queries, API query languages such as GraphQL, REST, and so forth. Composing such queries can be used to derive insightful information from data stored in multiple tables. These results are typically processed in the form of charts or graphs to enable users to quickly visualize the results and facilitate data-driven decision making.

Although common database queries (e.g., SQL queries) are often predefined and incorporated in commercial products, any new or follow-up queries still need to be manually coded by the analysts. Such static interactions between database queries and consumption of the corresponding results need time-consuming manual intervention and result in slow feedback cycles. It is vastly more efficient to have non-technical users (e.g., business leaders, doctors, or other users of the data) directly interact with the analytics tables via natural language (NL) queries that abstract away the underlying query language (e.g., SQL) code. Defining the database query needs a strong understanding of database schema and query language syntax and can quickly get overwhelming for beginners and non-technical stakeholders. Efforts to bridge this communication gap have led to the development of a new type of processing called natural language interfaces for databases (NLIDB). This natural search capability has become more popular over recent years as companies are developing deep-learning approaches for natural language to logical form (NL2LF) such as natural language to SQL (NL2SQL).

Logical form can refer to (i) programming query languages, (ii) intermediate forms, and/or (iii) programming languages. Programming query languages can include database query languages, and examples of programming query languages include, but are not limited to, SQL, PQL, GraphQL, SPARQL, and the like. Intermediate forms can refer to machine-oriented languages and/or meaning representation languages (MRLs) such as OMRL, AMRL, and the like. Examples of programming languages include, but are not limited to, Python, C++, Java, Ruby, and the like. NL2SQL seeks to transform natural language questions to SQL, allowing individuals to run unstructured queries against databases. The converted SQL could also enable digital assistants such as chatbots and others to improve their responses when the answer can be found in different databases or tables with different schemas.

In some instances, NL2SQL transforms natural language to SQL using generative artificial intelligence models such as generative models. A generative model is a type of artificial intelligence (AI) that is trained to understand, generate, and manipulate human language (e.g., text data) in a coherent and contextually relevant manner. Generative models have resulted in significant progress in natural language processing tasks such as text-to-code (e.g., text-to-SQL), text generation and translation, and sentiment analysis. Due to their attention mechanisms and deep neural architectures, generative models excel at capturing nuanced language patterns and correlations in massive volumes of text data. generative models are designed to predict the next word or token in a sequence of text by computing a probability distribution over a fixed vocabulary for the next token based on the context of the preceding tokens. The prediction is achieved through a series of self-attention mechanisms incorporated in the generative models that assign varying degrees of importance to different parts of the input sequence that enable the generative models to make informed predictions. Generative models generate contextually appropriate and coherent text by learning a fixed vocabulary from enormous text corpora and predicting which token included in the fixed vocabulary should be the next token in an output sequence.

As discussed above, conventional generative models have fundamentally transformed the landscape of human-computer interaction by allowing users to interface with complex data systems through natural language. These generative models serve as intermediaries, translating everyday speech into specialized languages like SQL removing the need for users to understand technical syntax or data structures. As a result, individuals who are not versed in programming or database management can retrieve, manipulate, and analyze data simply by expressing their needs in plain language. For example, a user might request, “Show me all orders placed in March,” and the model is expected to convert this into an appropriate SQL query. This capability has expanded data accessibility across organizations, empowering professionals in fields such as finance, operations, and marketing to extract actionable insights without the traditional bottlenecks associated with technical dependencies.

Conventional generative models may be limited by their sensitivity to linguistic variations and their reliance on pattern matching over true semantic comprehension. The conventional generative models often falter when a user's intent is conveyed using different phrasing, punctuation, or sequence of information. For instance, the queries, “List employees hired in 2023,” “Show 2023 hires,” or “Employees who started in 2023” all seek the same result, yet the generative model may interpret each as a distinct task and produce inconsistent SQL queries in response. This problem is compounded when users introduce compound instructions or qualifiers, for example, “List employees hired in 2023, excluding temporary staff,” versus “Exclude temporary staff and show employees hired in 2023.” The lack of resilience to paraphrasing and syntactic variation often leads to inconsistent or incorrect results undermining the reliability of these tools for important applications.

These challenges highlight a necessity for generative models that demonstrate robustness to a range of natural language variability encountered in practical settings. In everyday environments, users naturally employ diverse expressions, reorder their requests, use various punctuation marks, and include differing levels of detail or qualifiers. The order in which information is presented, the choice of keywords, and even the selection of a subset of instructions from a multifaceted query can all vary. For example, one user might state, “For Q1, display product sales, but do not include items on backorder,” while another might say, “Exclude backordered items, and show sales by product for Q1.” Inconsistent interpretation of these requests can lead to confusion, operational inefficiency, and loss of trust in automated systems. Achieving consistent results regardless of these variations is important for fostering seamless human-computer collaboration.

The techniques, components, processes, and methods described herein present exemplary strategies for fine-tuning a generative model so that it becomes invariant to linguistic differences. To increase the model's resilience to user phrasing variations, a diverse set of training examples is incorporated into an augmented prompt that may include schema descriptions, business logic, and specific perturbation instructions. This training set contains multiple variants, (e.g., linguistic expressions that, while phrased differently, are intended to produce the same outcome). In this way, the generative model is exposed to the range of ways NL utterance can be expressed. The generative model can use these perturbation instructions to modify NL utterances, schema descriptions, and business logic, creating augmented training data that covers various forms, including paraphrased and reordered statements. Following this, a batch balancing operation or a suitable equivalent may be used to fine-tune the generative model, or another suitable model, with these augmented examples.

According to embodiments herein, a fine-tuned generative model may consistently produce the same correct output for semantically identical requests, invariant of paraphrasing, order of instructions, punctuation, verbosity, keyword selection, or the extraction of relevant portions from multipart questions, among others, brings substantial technical benefits. One technical improvement is reliability: users can trust that their intent will be captured and executed precisely, mitigating or eliminating a need to repeatedly rephrase or clarify instructions. This reliability may streamline workflows by reducing unnecessary iterations and decreasing the likelihood of errors resulting from misinterpretation. The fine-tuned generative model's resilience also enables efficient handling of complex, multipart queries, where only a subset of instructions may be relevant to a desired action. This capability ensures that even nuanced or context-rich requests are parsed and executed accurately the first time, saving time and reducing cognitive load on users.

Systems built on linguistic invariant fine-tuned generative models are more intuitive and accessible, encouraging broader adoption among non-technical users and supporting organizational data democratization. Consistent query translation enhances integration with downstream tools and automated processes as uniform outputs reduce a need for custom error handling or output normalization. The ability to handle compound and paraphrased instructions accurately supports more sophisticated analytical workflows and enables advanced automation scenarios. These technical advantages lead to higher user satisfaction, improved decision-making, and/or greater operational efficiency, setting a new benchmark for data-driven tools and interfaces that must reliably translate human intent into actionable system commands regardless of the variability inherent in natural language.

Moreover, a linguistic invariant fine-tuned generative model that delivers consistent results regardless of linguistic variation offers significant technical improvements in terms of processing power, memory usage, and time savings. By reducing the number of iterations needed to achieve the correct output, the fine-tuned generative models lessen the computational burden on backend systems. For example, when a user's first query produces the correct result, there is no need for additional parsing, repeated API calls, or supplementary database queries, all of which consume processing cycles and memory resources. Fewer iterations mean less redundant data movement and reduced strain on computational infrastructure, which translates to lower operational costs and improved system responsiveness. Time savings become particularly evident in collaborative settings, where teams may otherwise spend extended periods clarifying ambiguous queries or reconciling inconsistent outputs. For instance, a sales manager might ask, “Give me this quarter's revenue for online sales only,” while a colleague later requests, “Show revenue generated online this quarter.” A fine-tuned generative model that recognizes both as equivalent mitigates a need for repeated processing and manual result comparison. Similarly, when parsing multipart instructions, efficient extraction of relevant commands prevents unnecessary execution of extraneous sub-queries, further conserving resources. As a result, organizations benefit from faster query resolution, more responsive data tools, and reduced infrastructure load, which together enhance both the user experience and the scalability of data-driven solutions.

In practical application, integrating a fine-tuned generative model that reliably produces consistent and accurate translations of user intent into specialized languages, regardless of linguistic variation, provides substantial utility within computing environments. This integration enables the deployment of user-friendly interfaces across a range of industries, from finance and healthcare to logistics and education, where complex data queries are routinely needed by non-technical personnel. The fine-tuned generative model's ability to maintain uniformity in query generation ensures that downstream processes remain predictable and dependable. The practical value extends to cloud-based services, enterprise resource planning (ERP) systems, and business intelligence (BI) platforms, where the fine-tuned generative model's robust performance under real-world conditions ensures that chatbots deliver tangible improvements in efficiency, accuracy, and/or user satisfaction.

### II. OVERVIEW OF AGENTS AND NL2SQL FRAMEWORK

An agent (also referred to as a skill, chatbot, chatterbot, talkbot, digital assistant, or the like) is a computer program that can perform conversations with end users. The agent can generally respond to natural-language messages (e.g., questions or comments) through a messaging application that uses natural-language messages. Enterprises may use one or more agent systems to communicate with end users through a messaging application. The messaging application, which may be referred to as a channel, may be an end user preferred messaging application that the end user has already installed and familiar with. Thus, the end user does not need to download and install new applications in order to chat with the agent system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile and web app extensions that extend native or hybrid/responsive mobile apps or web applications with chat capabilities, or voice based input (such as devices or apps with interfaces that use Siri, Cortana, Google Voice, or other speech input for interaction).

End users may interact with the agent system through a conversational interaction (sometimes referred to as a conversational user interface (UI)), just as interactions between people. In some cases, the interaction may include the end user providing a utterance such as query: “Please retrieve all invoices greater than ten thousand dollars for the last four years for Customer Y”, to the agent, and the agent responding with a natural language response for the query based on translation of the user's natural language query to a SQL query and execution of the SQL query on an appropriate database.

In some embodiments, the agent system may intelligently handle end user interactions without interaction with an administrator or developer of the agent system. For example, an end user may send one or more messages to the agent system in order to achieve a desired goal. A message may include certain content, such as natural language text, audio, image, video, or other method of conveying a message. In some embodiments, the agent system may convert the content into a standardized logical form (e.g., a SQL query). The agent system may also prompt the end user for additional input parameters or request other additional information. In some embodiments, the agent system may also initiate communication with the end user, rather than passively responding to end user utterances. Described herein are various techniques for identifying an explicit or implicit invocation of an agent system and determining an input for the agent system being invoked.

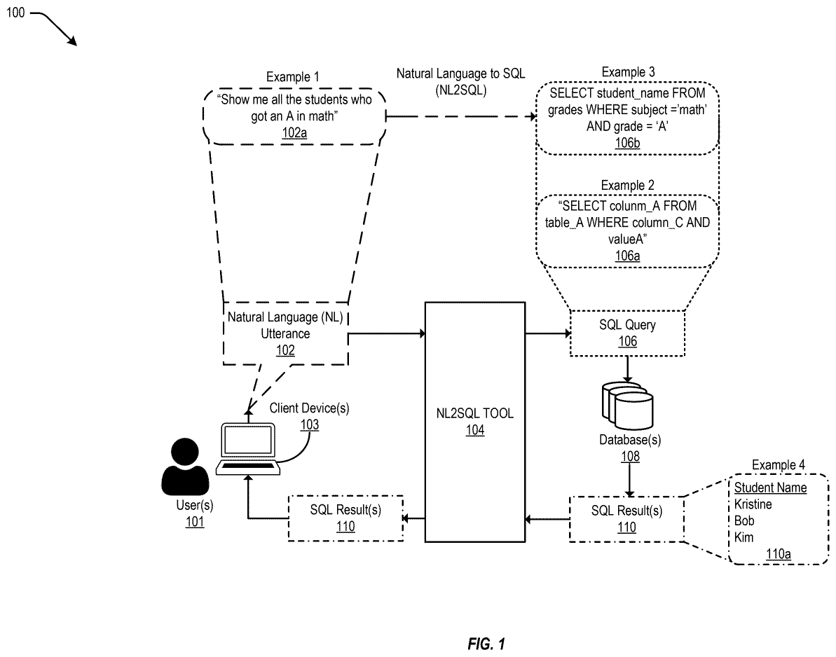

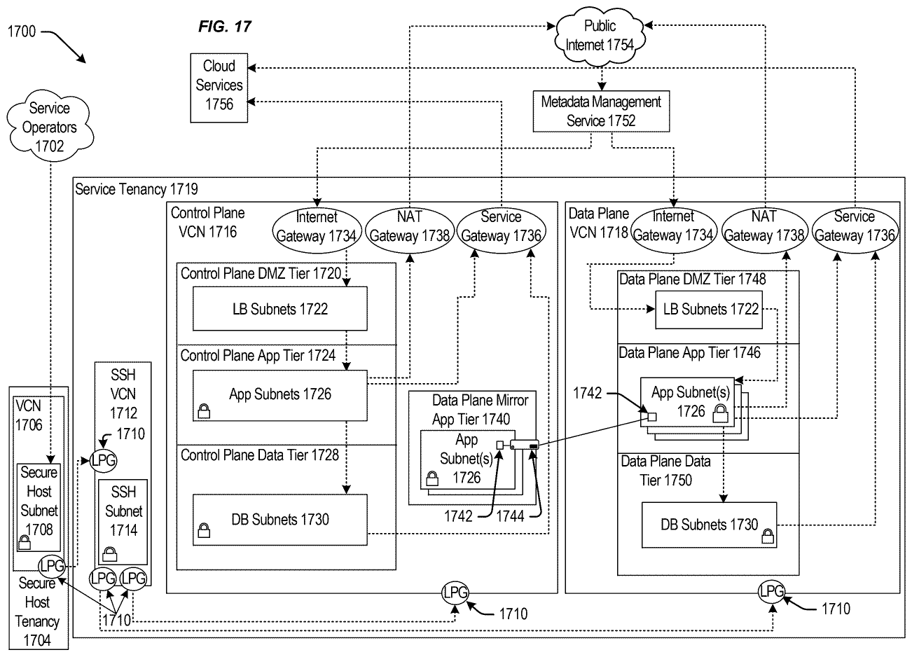

FIG. 1 depicts a simplified diagram of an environment 100 incorporating an exemplary NL2SQL tool, according to various embodiments. Environment 100 includes an NL2SQL tool 104 that enables users 101 to receive (i) a translated version of a natural language utterance 102 (e.g., a natural language query translated into a given programming language such as SQL), and/or (ii) a result of executing an action related to a natural language utterance 102 (e.g., a natural language query translated into a given programming language such as SQL, which is then executed on a database to retrieve a result for query). As shown in FIG. 1, the NL2SQL tool 104 is configured to generate a SQL query 106 and one or more SQL query result(s) 110 based on the provided natural language utterance 102, however other examples may implement tasks in addition to or alternative to SQL query generation (e.g., schema checking, schema linking, sentence completion, extraction of key information, debugging, and other SQL related tasks). The NL2SQL tool 104 can be implemented using software only, hardware only, firmware only, or any combination of hardware, software, and/or firmware. In some instances, the environment 100 is part of an Infrastructure as a Service (IaaS) cloud service (described in more detail with respect to FIGS. 17-21) and the NL2SQL tool can be implemented as part of the IaaS by leveraging the scalable computing resources and storage capabilities provided by the IaaS provider to process and manage large volumes of data and complex computations. This setup can allow the NL2SQL tool 104 to deliver real-time, responsive interactions while ensure high availability, security, and performance scalability to meet varying demand levels. The NL2SQL tool 104 can be embodied or implemented in various physical systems or devices, such as in a computer, a mobile phone, a watch, an appliance, a vehicle, and the like. For the purposes of this example, the NL2SQL tool 104 generates and accepts queries related to SQL, but it should be understood that the techniques described herein are not limited to SQL and the NL2SQL tool 104 can be configured as any other natural language to logical form (NL2LF) tool capable of generating queries and statements using other programming languages (e.g., PRQL, GraphQL, WebAssembly, Python, R, Java, N1QL, and the like).

As illustrated in FIG. 1, a user 101 provides a user input to the NL2SQL tool 104. The user input can be or can include a natural language utterance 102. The natural language utterance can be in text form, such as when the user types a sentence, a question, a text fragment, or phrase and provides it as an input to the NL2SQL tool 104 via client device(s) 103. The client devices(s) 103 can be configured to communicate with the NL2SQL tool 104, provide the natural language utterance 102 to the NL2SQL tool 104 and receive outputs from the NL2SQL tool 104. In some implementations, the natural language utterance 102 can be in speech form, which may be converted to text form and provided to the NL2SQL tool 104. As an example, a natural language utterance 102 such as 102a “Show me all the students who got an A in math” can be spoken by the user 101 and the NL2SQL tool 104 may be configured as a standalone or via a plug-in, or make use of some other audio-to-text translator, configured to translate the audio into text for further processing.

The NL2SQL tool 104 may be or may make use of one or more generative artificial intelligence models such as LLMs configured to generate a SQL query 106 (e.g., 106a or 106b) based on the natural language utterance 102. The NL2SQL tool 104 may receive a prompt including the natural language utterance 102 to generate a SQL query 106 that it is relevant to the user 101 preferences. In some implementations, the user 101 and/or client device 103 generate a prompt including the natural language utterance 102 before providing the prompt to the NL2SQL tool 104. In other implementations, the NL2SQL tool 104 receives the natural language utterance 102 and generates the prompt itself, e.g., populates slots of a prompt template, before providing the prompt to a trained generative artificial intelligence model.

The NL2SQL tool 104 converts the natural language utterance 102 (as in example 1 depicted in FIG. 1) to the SQL query 106. The NL2SQL tool 104 may consider schema information corresponding to one or more databases 108 to generate the SQL query 106. The SQL query 106 (as in examples 2 or 3 depicted in FIG. 1) may be executed on database(s) 108 to obtain a SQL result 110. As a non-limiting example, SQL result 110 can be a list of students who got an A in math based on a generated SQL query 106. The SQL result(s) 110 can be provided back to the user 101 by the NL2SQL tool 104. In some instances, the SQL result(s) 110 are reported back to the user 101 as raw output. In other instances, the SQL result(s) 110 are reported back to the user 101 as part of a natural language response (e.g., a summary) generated by the one or more generative artificial intelligence models in response to the natural language utterance 102. In other instances, the SQL result(s) 110 are reported back to the user 101 as part of a natural language response (e.g., a summary) generated by the one or more generative artificial intelligence models and/or with a visualization (e.g., a bar chart, pie chart, table, or the like) generated by one or more generative artificial intelligence models and/or analytic subsystems in response to the natural language utterance 102. The user 101 may receive the SQL result(s) 110 through the client device(s) 103. Additionally or alternatively, the NL2SQL tool 104 may provide the SQL query 106 to the user(s) via some other means such as an email communication, SMS message, or other type of notification receivable on one or more other computing devices. In some implementations, the SQL query 106 is provided to the user(s) in addition to or without running the SQL query 106 on the database(s) 108 to obtain SQL result(s) 110 (e.g., as part of a feedback request to validate the SQL query 106).

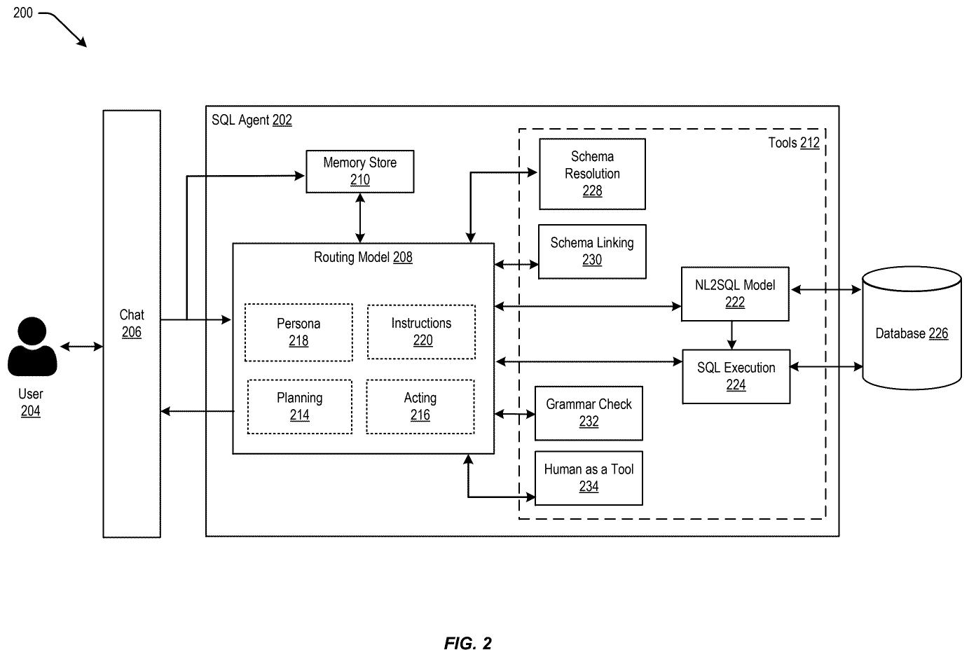

FIG. 2 is a simplified block diagram of a SQL agent system 200 according to certain embodiments. SQL agent system 200 is a computing system that can be implemented in software only, hardware only, firmware only, or any combination of hardware, software, and/or firmware. The SQL agent system 200 can convert natural language questions into SQL to help users complete their data related tasks by leveraging the power of generative artificial intelligence such as LLMs. In addition to their language capabilities (e.g., sentence completion, summarization, extraction of key information from text passages), generative artificial intelligence can generate SQL statements. The purpose of the SQL agent system 200 is to enable users to talk to their databases with the least amount of effort. This may include the SQL agent system 200 interpreting user requests in natural language, reviewing database schema, implementing schema linking (e.g. identify names of tables and columns in natural language questions), generating SQL queries and even executing the SQL statements. In certain embodiments, the SQL agent system 200 can be used to implement one or more tools related to SQL generation, execution, and/or review (e.g., NL2SQL tool 104 as described with respect to FIG. 1). The SQL agent system 200 can include a SQL agent 202 capable of converting a natural language question into a SQL query.

A user 204 can participate in a chat 206 (also described herein as a conversation or an interaction) with the SQL agent 202. The user 204 may interact with the chat 206 via a user interface such as a graphical user interface or conversational user interface. As an example, the user 204 may provide a user input to the SQL agent 202 via a user interface element such as a chat window. The chat 206 can include one or more inputs from the user 204 and one or more responses from the SQL agent 202. The chat 206 may correspond to one or more chat sessions between the user 204 and the SQL agent 202. During the chat 206, the user 204 provides a natural language utterance that can be processed by the SQL agent 202. The natural language utterance can include a question related to a database or SQL generation.

One or more user inputs provided by the user 204 via the chat 206 are provided to the SQL agent 202. Included in the SQL agent 202 are a routing model 208, a memory store 210 and tools 212. The routing model 208 and memory store 210 receive user inputs such as natural language utterances from the chat 206. The memory store 210 can store a chat history for the user 204 and contextual information related to the user 204, the chat 206, and/or other pieces of information relevant to the NL2SQL operations such as in-context examples, APIs, external knowledge, and the like. The tools 212 can include functions, APIs, and trained machine learning models that can be used by the SQL agent 202 to interact with external systems (e.g., database 226, external knowledge bases) and/or generate SQL statements.

The routing model 208 may be or may make use of one or more generative artificial intelligence models such as LLMs. The routing model 208 can include a planning 214 component and an acting 216 component (e.g., trained task). Planning 214 includes generating a plan that is comprised of a sequence of steps for execution (acting 216), which includes executing the steps in a generated plan using one or more tools 212. In some examples, the routing model 208 may retrieve contextual information related to the user 204 and/or chat 206 from the memory store 210 during planning 214 to improve plan generation. Planning 214 may further include determining a new plan based on a result produced by acting 216 and the execution of a previous plan.

One or more tools 212 supported by the SQL agent 202 may be LLM-based tools configured to receive a prompt and generate a result based at least in part on the prompt. As an example, the tools 212 can include an LLM-based NL2SQL model 222 that generates a SQL statement based on a prompt including a natural language utterance provided by the user 204 (e.g., as described in FIG. 1). In some instances, the routing model 208 can generate a prompt based on a natural language utterance received from the user 204. In some examples, steps for generating a prompt can be included in a plan generated by planning 214 and the prompt may be generated by acting 216. A prompt can include a persona 218 and instructions 220. The persona 218 can be selected from a set of available personas (see Table 1 for a non-limiting list of exemplary personas). Including the persona 218 in a prompt for an LLM may improve accuracy of generated responses and customize responses generated by an LLM to the needs of the user 204. In some examples, planning 214 may select a tool from the tools 212 based on the persona 218.

TABLE 1

| Example Persona | Example Description |
|---|---|
| Junior Developer | A user having limited to no experience in writing SQL |
| | queries that needs assistance in writing and optimizing SQL |
| | queries. |
| Expert Developer | A user with several years of experience writing SQL |
| | queries. |
| Business Analyst | A user with strong context about the needs of a company |
| | and wants quick data insights without deep SQL knowledge. |
| Data Scientist | A user focused on extracting and analyzing data efficiently. |

Instructions 220 describe the knowledge bases and tools available to the SQL agent 202. Instructions 220 can be included in a prompt for LLM-based tools and may guide a tool to generate a response relevant to preferences of user 204. Additionally, or alternatively, the prompt can include a table schema, description of columns in the table schema, context, in-context examples, additional instructions, a user question, or any combination thereof. In some examples, context may include contextual information related to the user 204 and/or chat 206 history and may be retrieved from the memory store 210 by the routing model 208. The prompt may further include database schema information corresponding to a database 226.

The routing model 208 may provide the generated prompt to a tool from the tools 212 selected by planning 214. As an example, the NL2SQL model 222 receives a prompt provided by the routing model 208 and generates a SQL query based on the prompt. The NL2SQL model 222 can be trained to convert a natural language question into a SQL query to help the user 204 complete data related tasks. In some examples, the SQL query generated by the NL2SQL model 222 is returned to the user 204 via the chat 206. Additionally, or alternatively, the generated SQL query is provided to a SQL execution 224 tool that is configured to execute SQL queries on the database 226. SQL execution 224 may receive a SQL result from the database 226 and provide the SQL result to the routing model 208. The routing model 208 may provide the SQL result to the user 204 via the chat 206. In some implementations, the routing model 208 may identify an error in the SQL result or determine the SQL query and/or result does not correspond to user 204 needs and generate new plan using planning 214 to correct the error or generate a new SQL query.

Additional examples of tools include, but are not limited to, schema resolution 228, schema linking 230, grammar check 232, and human as a tool 234. Schema resolution 228 may be configured to check for and/or fix any errors within a SQL statement. The SQL agent 202 may use schema resolution 228 after a SQL query is generated by the NL2SQL model 222. Schema linking 230 may be configured to identify proper references to schema values (e.g., tables, columns, condition values) based on schema information and query patterns. Schema linking 230 can include content-based schema linking for mapping values, and name-based schema linking for mapping table and column names for SQL generation. For large schemas, retrieval augmented generation (RAG)-based schema linking may be implemented to retrieve a relevant subset of the schema. Schemas can be stored in a knowledge base (e.g., memory store 210) and relevant schema information can be retrieved based on a natural language query provided by the user 204. In some implementations, the knowledge base includes external data stores and schema linking 230 can include performing a web search to identify relevant schema. The SQL agent 202 may be unable to resolve ambiguities during schema linking 230. In such examples, the SQL agent 202 can ask the user 204 clarifying questions to resolve the ambiguities and/or acquire missing information to resolve the ambiguities.

Also included in the tools 212 is a grammar check 232 that can review grammar of generated statements. Tools 212 can also include human as a tool 234. The SQL agent 202 may seek human input for clarification and disambiguation. Human as a tool 234 may be used to supplement one or more additional tools of the set of tools 212 with human input or intervention. Human as a tool 234 can include asking the user 204 or another user such as a developer for information for correcting previous generations.

The SQL agent 202 may use a singular tool or a combination of tools 212 to generate a response to the user 204. The routing model 208 can select a tool and/or generate a prompt for the selected tool based on a natural language utterance received via the chat 206. The routing model 208 receives an output from the selected tool based on the prompt and/or context provided to the selected tool. In some implementations, the output generated by the selected tool is provided to the user 201 via the chat 206 as received by the routing model 208 (e.g., without additional modifications to the output).

In some implementations, the routing model 208 responds to the user 204 which provided the original query as part of a two-way conversation (e.g., via chat 206). The natural language response may include a natural language component (e.g., answers to questions, information, etc.) and/or a logical form component (e.g., a SQL query). In some embodiments, the routing model 208 may generate a natural language response containing the output generated by the selected tool. The routing model 208 may be configured to generate the natural language response and/or may use a response generation tool to generate the natural language response. The natural language response can be provided to the user 201 via the chat 206. In some implementations, the SQL agent 202 may provide a visualization of the generated output through a plot, table, graph, and the like, via the chat 206. As a particular example, the SQL agent 202 can use the schema linking 230 tool to identify names of table and columns in a natural language utterance (which is an example of NL utterance 102 with respect to FIG. 1) provided by the user 204 and then generate a SQL query using the NL2SQL model 222 based on the identified table and column names. The SQL query may be provided to the user 201 via the chat 206 as generated by the NL2SQL model 222. In some implementations, the routing model 208 may generate a natural language response containing the SQL query and provide the natural language response to the user 201 via the chat 206.

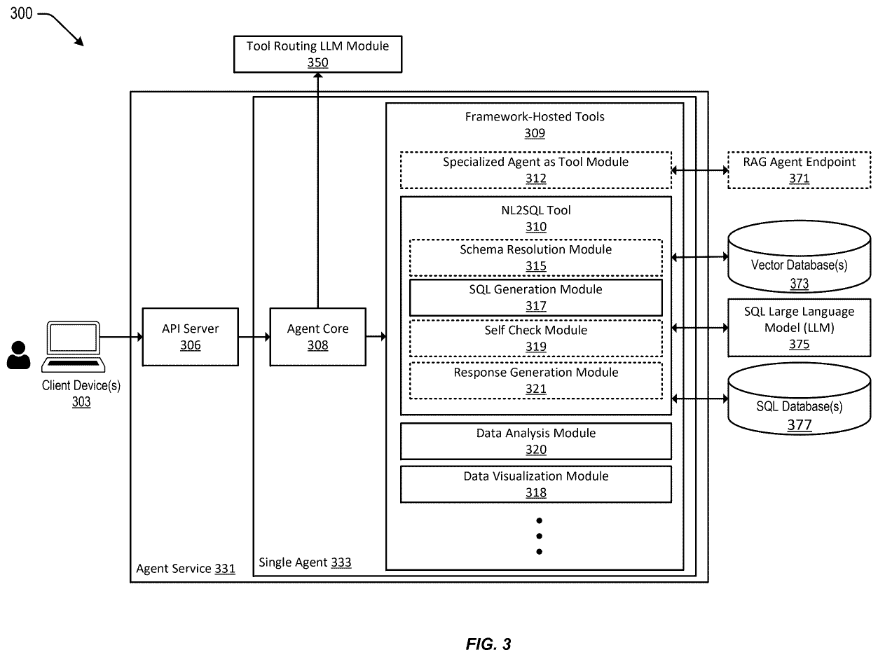

FIG. 3 depicts a simplified diagram 300 for an example generative AI SQL agent, according to various embodiments. As discussed in regard to FIGS. 1 and 2, user(s) (e.g., users 101 or 204) may use client device(s) 303 to submit a NL utterance and/or question to an agent service 331 by way of an API server 306. The API server 306 may be a software, hardware, and/or firmware component that enables one or more applications (e.g., cloud applications) to enable communication as an intermediary between the client device(s) 303 and the agents. The API server 306 may identify a specific agent (e.g., single agent 333), or multiple agents, to handle the instance (e.g., by agent specialty or user preference) and select an agent core 308. The agent core 308 may be configured with pass-through routing or, if additional tools are included in the agent, a specific routing (e.g., ReAct routing) may be implemented. The agent core 308 may handle multi-step (or iterated) SQL resolution, generation, and/or execution. By way of a non-limiting example, in analytical use cases using unique software packages (e.g., Oracle™ Analytics Cloud (OAC), Tableau™, etc.), a single analytical dashboard may generate multiple SQL queries using output from previous inputs (e.g., by way of Churn analysis, Funnel analysis, cohort analysis, etc.). The agent core 308 may access a tool routing LLM module 350 in order to identify, select, utilize, and/or train one or more LLM(s) that may suitably apply to the utterance received from the client device(s) 303.

The agent core 308 may include one or more framework-hosted tools 309 for addressing various functions. For example, the framework-hosted tools 309 may include a specialized agent as tool module 312 which may be in communication with a retrieval augmented generation (RAG) endpoint 371. The RAG endpoint 371 may improve an efficacy of one or more LLMs by suitably leveraging various sources of data. For example, retrieving data/documents relevant to the utterance (e.g., question, statement, task, etc.) and providing them as context for the LLM as either labeled or unlabeled data. The RAG endpoint 371 may provide support to the agent core and maintain up-to-date information based at least in part on other trained LLMs and/or agent cores (not depicted), and/or access domain-specific knowledge.

Included in the frame-work hosted tools 309 is a NL2SQL tool 310, which is an example of the NL2SQL model 222 with respect to FIG. 2. The NL2SQL tool 310 includes, without limitation, modules 315, 317, 319, and 321. Schema resolution module 315 may function to receive input from the client device(s) 303 requesting the NL2SQL tool 310 check one or more schema for any errors (e.g., syntax errors, sematic errors, etc.) and fix the errors (or recommend a fix). The agent core 308 may provide explanations to the client device(s) 303 about each fix performed. The explanations may be provided in natural language. In some examples, the NL2SQL tool 310 may attempt to automatically resolve the errors if possible and ask clarification questions (e.g., as output to the client device(s) 303) where suitably needed. If the error cannot be resolved, the error may be displayed to the user(s). As an example, the different types of errors that an agent core 308 (which is an example component of SQL agent 202 with respect to FIG. 2) may return can include syntax errors and semantic errors. The schema resolution module 315 may reference one or more vector database(s) 373 to obtain and/or store schema.

Also included in the NL2SQL tool 310 is a SQL generation module 317. The SQL generation module 317 may take the utterance received from the client device(s) 303 and construct a SQL query. To do this, the NL2SQL tool 310 may access one or more generative artificial intelligence models such as LLMs (e.g., SQL LLM 375) that may have been trained on generating SQL queries. An LLM may receive the utterance from the NL2SQL tool 310 and may translate the utterance into a relevant SQL query. The SQL generation module 317 may then pass the received SQL query from the LLM to one or more additional modules. For example, the SQL generation module 317 may pass the SQL query returned from the LLM to a response generation module 321. The response generation module 321 may append the SQL query (optionally along with information related to the utterance) and return the SQL query to the client device(s) 303. In addition, or alternatively, the response generation module 321 may pass the SQL query to one or more SQL database(s) 377 to retrieve information related to the utterance. The NL2SQL tool 310 may utilize a self-check module 319, which may function with any one or more of the other modules. The self-check module 319 may automatically try to resolve errors associated with the SQL query and/or LLM prompt containing the utterance. The self-check module 319 may ask clarifying questions to the client device(s) 303 and/or the LLM to resolve the errors.

The framework-hosted tools 309 includes data analysis module 320 and a data visualization module 318. Each of 320 and 318 may function with any of the modules of the framework-hosted tools 309 in order to analyze various analytics and display the various analytics. The analytics may include analysis of schema, SQL queries, LLM accuracy, recommendations, or suitable equivalents.

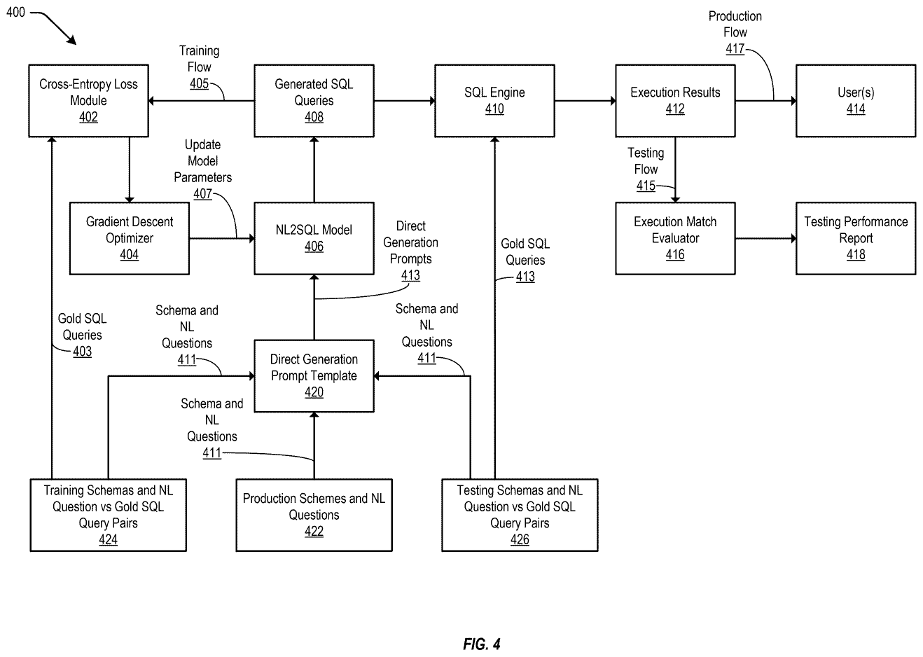

FIG. 4 depicts a simplified block diagram 400 for training, testing, and deployment or production of an NL2SQL Model, according to various embodiments. This simplified overview of training, testing, and inference depicts flows for a NL2SQL direct generation model (however it should be understood that similar steps could be implemented for a generation model that translates to an intermediate database query language which can be used to generate a query in a specific system query language or other for a generation model that translates to another programming language such as PRQL, GraphQL, WebAssembly, Python, R, Java, N1QL, and the like). A NL2SQL model is powered by a machine learning model(s) (e.g., an LLM) configured to convert a NL utterance (e.g., a query posed by a user using an agent) into a logical form, for example, an intermediate database query language such as OMRL or a system query language format, such as SQL or PGQL. If an intermediate database query language format is used then the intermediate database query language can be used to generate a query in a specific system query language (e.g., SQL), which can then be executed for querying a system such as a database to obtain an answer to the user's utterance. If a system query language format is used, then the system query language can be directly executed for querying a system such as a database to obtain an answer to the user's utterance.

In the specific context of this disclosure, the machine learning model(s) may be one or more generative models. A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original data set. This capability makes them particularly useful in a variety of applications, including image and voice generation, text or code synthesis, and more sophisticated tasks like unsupervised learning, semi-supervised learning, and domain adaptation.

One type of generative model is a large language model (LLM). Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times and inference latency times.

A mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

Transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

Following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

Integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

Another type of generative model is a large multimodal model (LMM). A large multimodal model is an advanced machine learning model capable of processing and generating data across multiple modalities, such as text, images, audio, and video. These models integrate diverse data sets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is fundamental. By leveraging diverse data sets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse data sets that include paired data from different modalities. This computationally intensive process often needs specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that need understanding and synthesizing information from diverse data types. Effective preprocessing, rigorous training, and thorough evaluation are valuable to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

One goal of the NL2SQL model is to allow end users to interact with their systems, (e.g., SQL databases) through natural language rather than program specific language queries such as SQL queries. Using a NL2SQL service, users such as business analysts can extract information from their systems without thorough knowledge of a specific programming language and system schemas. The NL2SQL model is an LLM, which is an advanced type of artificial intelligence model designed to understand and generate human language. These models are trained on vast amounts of text data and leverage deep learning techniques to perform a variety of natural language processing tasks, such as text generation, translation, summarization, and answering questions. In the below description, the LLM (NL2SQL model) is designed and trained to convert natural language queries into SQL queries. This involves understanding the semantics of the natural language input, mapping it to the corresponding database schema, and generating a syntactically and semantically correct SQL query that can retrieve the desired information from the database. However, it should be understood that similar techniques could be implemented for other programming languages including other system query languages such as PGQL and/or other intermediate logical forms such as MRL or OMRL.

The input to the Natural Language-to-SQL (NL2SQL) model is a natural language question.
For example:
   “Get me the list of employees from Australia.”
The main output from the NL2SQL model is a SQL query.
For example:
   SELECT employee_id, employee_name FROM Employee WHERE country=“Australia”.
Another important input to the NL2SQL model is the database schema that helps the model to identify relevant tables and columns in the SQL output construction.
For example:

```
CREATE TABLE Employee (
  employee_id TEXT(12) NOT NULL,
  employee_name TEXT(100) NOT NULL,
  birth_date DATE NOT NULL,
  hire_date DATE NOT NULL,
  country TEXT(100),
...
)
CREATE TABLE JobTitle (
...
)
...
```

Described herein is a pre-trained NL2SQL model developed based on instruction fine-tuning of LLMs to provide this NL2SQL direct generation capability, e.g., the mapping of (Database Schema, NL Question)→SQL Query. Below is the summary of how the NL2SQL direct generation capability is implemented via instruction fine-tuning.

Data to train a NL2SQL model includes multiple database schemas defined as SQL CREATE TABLE statements:
Table names
Column names and types
Primary and foreign keys
Other constraints

### One Database Schema Example:

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Each database schema can be associated with multiple pairs of natural language questions and corresponding SQL queries.

### Example of NL Question and Corresponding SQL Query:

NL Question: “What is the name of the employee with salary greater than 100000 and with the most certificates to fly planes more than 5000?”
SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1”

Each question-query pair and its corresponding database schema are populated following a NL2SQL direct generation prompt template to create one direct generation prompt example:
Direction NL2SQL Generation Prompt Example:
   Given an input Question, create a syntactically correct Oracle SQL query to run.
   Pay attention to using only the column names that you can see in the schema description.
   Be careful to not query for columns that do not exist. Also, pay attention to which column is in which table.
   Please double check the SQL query you generate.
   DO NOT use alias in the SELECT clauses.
   Only use the tables listed below.

```
CREATE TABLE aircraft (
  aid NUMERIC(9, 0),
  name TEXT(30),
  distance NUMERIC(6, 0),
  PRIMARY KEY (aid)
)
CREATE TABLE employee (
  eid NUMERIC(9, 0),
  name TEXT(30),
  salary NUMERIC(10, 2),
  PRIMARY KEY (eid)
)
CREATE TABLE certificate (
  eid NUMERIC(9, 0),
  aid NUMERIC(9, 0),
  PRIMARY KEY (eid, aid),
  FOREIGN KEY(aid) REFERENCES aircraft (aid),
  FOREIGN KEY(eid) REFERENCES employee (eid)
)
CREATE TABLE flight (
  flno NUMERIC(4, 0),
  origin TEXT(20),
  destination TEXT(20),
  distance NUMERIC(6, 0),
  departure_date DATE,
  arrival_date DATE,
  price NUMERIC(7, 2),
  aid NUMERIC(9, 0),
  PRIMARY KEY (flno),
  FOREIGN KEY(aid) REFERENCES aircraft (aid)
)
```

Question: What is the name of the employee with salary greater than 100000 and with the most certificates to fly planes more than 5000?
SQL: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1”

The prompt example can then be sent to the LLM model to generate the SQL query during training and testing phases. The gold (ground truth) SQL Query: “SELECT T1.name FROM employee AS T1 JOIN certificate AS T2 ON T1.eid=T2.eid JOIN aircraft AS T3 ON T2.aid=T3.aid WHERE T3.distance>5000 AND T1.salary>100000 GROUP BY T1.eid ORDER BY count (*) DESC LIMIT 1” is used to evaluate the generated SQL query using a loss function such as cross-entropy loss (e.g., using cross-entropy loss module) in training and a performance metric such as execution match in testing. For execution match, both gold and generated SQL queries are executed on the database using the SQL engine. The result sets of the gold and generated SQL queries are compared to check if the results sets are a match.

The training and testing flows start at either a training schemas and NL question versus (vs) gold SQL query pairs block 424 or a testing schemas and NL question versus gold SQL query pairs block 426, respectively, where training and testing data is collected (e.g., acquired or accessed). The data collection can include exploring various data sources such as public datasets, private data collections, or real-time data streams, depending on a project's needs. In some instances, a data source is a public or online repository of information or examples pertinent to a general or target domain space. Many domains have publicly available datasets provided by governments, universities, or organizations. For example, many government and private entities offer datasets on healthcare, environmental data, and more through various portals. For proprietary needs, data might be available through partnerships or purchases from private companies that specialize in data aggregation. In other instances, a data source is a private repository of information or examples pertinent to a general or target domain space. For example, a data source can be a storage device that stores various schemas and natural language questions (including labels for corresponding gold SQL queries 403, 413).

Preprocessing may be performed on the training and testing data (from 424, 426 respectively), serving as a bridge between raw data acquisition and effective model training. The primary objective of preprocessing is to transform raw data into a format that is more suitable and efficient for analysis, ensuring that the data fed into machine learning algorithms is clean, consistent, and relevant. This step can be useful because raw data often comes with a variety of issues such as missing values, noise, irrelevant information, and inconsistencies that can significantly hinder the performance of a model. By standardizing and cleaning the data beforehand, preprocessing helps in enhancing the accuracy and efficiency of the subsequent analysis, making the data more representative of the underlying problem the model aims to solve. At block 420, the preprocessing includes populating the training and testing data (e.g., schema and NL questions 411) into the direct generation prompt template (as described above) to create direct generation prompts from which the NL2SQL model generates SQL queries.

Once collected, generated, preprocessed, and/or labeled, the data may then be split into the training and testing datasets. The training and testing datasets may comprise the raw data and/or preprocessed data. The training and testing datasets are typically split into at least three subsets of data: training, validation, and testing. The training set is used to fit the model, where the machine learning model learns to make inferences based on the training data. The validation set, on the other hand, is utilized to tune hyperparameters and prevent overfitting by providing a sandbox for model selection. Finally, the test set serves as a new and unseen dataset for the model, used to simulate real-world application and evaluate the final model's performance. The process of splitting ensures that the model can perform well not just on the data it was trained on, but also on new, unseen data, thereby validating and testing its ability to generalize.

Various techniques can be employed to split the data effectively, with each method aiming to maintain a good representation of the overall dataset in each subset. A simple random split (e.g., a 70/20/10%, 80/10/10%, or 60/25/15%) is the most straightforward approach, where examples from the data are randomly assigned to each of the three sets. However, more sophisticated methods may be necessary to preserve the underlying distribution of data. For instance, stratified sampling may be used to ensure that each split reflects the overall distribution of a specific variable, particularly useful in cases where certain categories or outcomes are underrepresented. Another technique, k-fold cross-validation, involves rotating the validation set across different subsets of the data, maximizing the use of available data for training while still holding out portions for validation. These methods help in achieving more robust and reliable model evaluation and are useful in the development of predictive models that perform consistently across varied datasets.

At this stage, hyperparameters may also be acquired or set for the training and testing. The hyperparameters control the overall behavior of the models. Unlike model parameters that are learned automatically during training, hyperparameters are set before training begins and have a significant impact on the performance of the model. For example, in an LLM, hyperparameters include the learning rate, batch size, number of layers, number of attention heads, hidden layer size, dropout rate, weight decay, sequence length, and embedding dimension, among others. These settings can determine how quickly a model learns, its capacity to generalize from training data to unseen data, and its overall complexity. Correctly setting hyperparameters is important because inappropriate values can lead to models that underfit or overfit the data. Underfitting occurs when a model is too simple to learn the underlying pattern of the data, and overfitting happens when a model is too complex, learning the noise in the training data as if it were signal.

At block 420, the direct generation prompts (for the training and testing data) are input into the NL2SQL model (at block 406) via a training and testing subsystem for training and/or testing. The training and testing subsystem is comprised of a combination of specialized hardware and software to efficiently handle the computational demands needed for training, validating, and testing a machine learning model. On the hardware side, high-performance GPUs (Graphics Processing Units) may be used for their ability to perform parallel processing, drastically speeding up the training of complex models, especially deep learning networks. CPUs (Central Processing Units), while generally slower for this task, may also be used for less complex model training or when parallel processing is less critical. TPUs (Tensor Processing Units), designed specifically for tensor calculations, provide another level of optimization for machine learning tasks. On the software side, a variety of frameworks and libraries may be utilized, including TensorFlow, PyTorch, Keras, and scikit-learn. These tools offer comprehensive libraries and functions that facilitate the design, training, validation, and testing of a wide range of machine learning models across different computing platforms, whether local machines, cloud-based systems, or hybrid setups, enabling developers to focus more on model architecture and less on underlying computational details.

Training is the initial phase of developing machine learning models such as the NL2SQL model where the model learns to generate SQL queries (output at block 408) based on the data training data (e.g., training flow 405) provided from the training datasets. During this phase, the model iteratively adjusts its internal model parameters to achieve a preset optimization condition. At blocks 402 and 404, the preset optimization condition can be achieved by minimizing the difference between the model output (e.g., generated SQL queries) and the ground truth labels (e.g., gold SQL queries) in the training data. In some instances, the preset optimization condition can be achieved when the preset fixed number of iterations or epochs (full passes through the training dataset) is reached. In some instances, the preset optimization condition is achieved when the performance on the validation dataset stops improving or starts to degrade. In some instances, the preset optimization condition is achieved when a convergence criterion is met, such as when the change in the model parameters falls below a certain threshold between iterations. This process, known as fitting, is fundamental because it directly influences the accuracy and effectiveness of the model.

In an exemplary training phase performed by the training and testing subsystem, the training subset of data is input into the machine learning algorithms to find a set of model parameters (e.g., weights, coefficients, trees, feature importance, and/or biases) that minimizes or maximizes an objective function (e.g., a loss function, a cost function, a contrastive loss function, a cross-entropy loss function, etc.). To train the machine learning algorithms to achieve accurate predictions, “errors” (e.g., a difference between a predicted label and the ground truth label) need to be minimized. In order to minimize the errors (blocks 402 and 404), the model parameters 407 can be configured to be incrementally updated by minimizing the objective function over the training phase (“optimization”). Various different techniques (e.g., stochastic gradient descent) may be used to perform the optimization. For example, to train machine learning algorithms such as an LLM, optimization can be done using back propagation. The current error is typically propagated backwards to a previous layer, where it is used to modify the weights and bias in such a way that the error is minimized. The weights are modified using the optimization function. Other techniques such as random feedback, Direct Feedback Alignment (DFA), Indirect Feedback Alignment (IFA), Hebbian learning, and the like can also be used to update the model parameters in a manner as to minimize or maximize an objective function. This cycle is repeated until a desired state (e.g., a predetermined minimum value of the objective function) is reached.

Validating is another phase of training where the model is checked for deficiencies in performance and the hyperparameters are optimized based on validation data provided from the training datasets. The validation data helps to evaluate the model's performance, such as accuracy, precision, recall, or F1-score, to gauge how well the model is likely to perform in real-world scenarios. Hyperparameter optimization, on the other hand, involves adjusting the settings that govern the model's learning process (e.g., learning rate, number of layers, size of the layers in neural networks) to find the combination that yields the best performance on the validation data. One optimization technique is grid search, where a set of predefined hyperparameter values are systematically evaluated. The model is trained with each combination of these values, and the combination that produces the best performance on the validation set is chosen. Although thorough, grid search can be computationally expensive and impractical when the hyperparameter space is large. A more efficient alternative optimization technique is random search, which samples hyperparameter combinations from a defined distribution randomly. This approach can in some instances find a good combination of hyperparameter values faster than grid search. Advanced methods like Bayesian optimization, genetic algorithms, and gradient-based optimization may also be used to find optimal hyperparameters more effectively. These techniques model the hyperparameter space and use statistical methods to intelligently explore the space, seeking hyperparameters that yield improvements in model performance.

Once a machine learning model has been trained and validated, it undergoes a final evaluation using the test data provided from the training and testing datasets, which is a separate subset of the data that has not been used during the training or validation phases. This step is important as it provides an unbiased assessment of the model's performance in simulating production operation. The test dataset serves as new, unseen data for the model, mimicking how the model would perform when deployed in actual use. During testing, the model's generated SQL queries (output at block 425) can be compared against the true values (e.g., gold SQL queries) in the test dataset using various performance metrics such as accuracy, precision, recall, and mean squared error, depending on the nature of the problem. Additionally, or alternatively, at blocks 410 and 412, the gold and generated SQL queries are executed on the corresponding database using a SQL engine (execution engine; see below in Production Flow section for detailed description) to obtain execution results. At block 416, the result sets (e.g., testing flow 415) from executing the gold and generated SQL queries are compared using an execution match evaluator to compute accuracy execution match metrics. This process helps to verify the generalizability of the model-its ability to perform well across different data samples and environments-highlighting potential issues like overfitting or underfitting and ensuring that the model is robust and reliable for practical applications. The NL2SQL model is fully validated and tested once the outputs have been reported (e.g., testing performance report) and deemed acceptable by user defined acceptance parameters (block 418). Acceptance parameters may be determined using correlation techniques such as Bland-Altman method and the Spearman's rank correlation coefficients and calculating performance metrics such as the error, accuracy, precision, recall, receiver operating characteristic curve (ROC), etc.

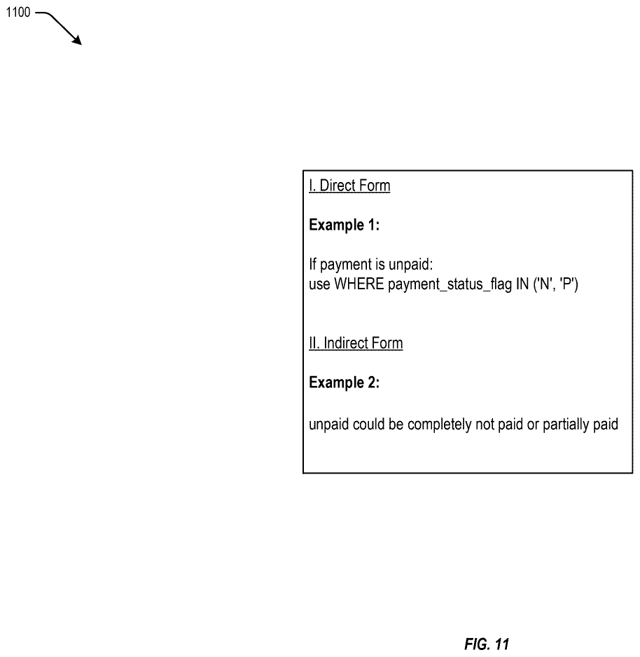

The production flow starts at block 422 where production schemas and natural language utterances (real-world input data) are input into the NL2SQL model via a production subsystem for inference. The production subsystem is comprised of various components for deploying machine learning models such as the NL2SQL model in a production environment. In some instances, the NL2SQL resides as a component of a larger system or service (e.g., use with an agent as described with respect to FIGS. 1-3). In some instances, the NL2SQL model and/or the inferences can be used by downstream applications to provide further information. For example, the inferences can be used to hold a conversation with a user as part of an agent or can be used to provide data analysis to a user via an analytical service such as analytics cloud-based service. Deploying the NL2SQL model includes moving the model(s) from a development environment (e.g., the training and testing subsystem, where it has been trained, validated, and tested), into a production environment where it can make inferences on real-world data (e.g., input data). This step typically starts with the model being saved after training, including its parameters and configuration such as final architecture and hyperparameters. It is then converted, if necessary, into a format that is suitable for deployment, depending on the deployment environment. For instance, a model trained in a developmental computing environment such as Python might be converted into a Java-friendly format for integration into a larger enterprise application. Deployment can be conducted on various platforms, including on-premises servers or cloud environments like OCI, AWS, Azure, Google, etc. (see below discussion of various computer and cloud architectures with respect to FIGS. 11-15).

At block 420, the input data (e.g., production schemas and natural language utterances) are populated into the direct generation prompt template (as described above) to create direct generation prompts from which the NL2SQL model generates SQL queries. At block 406, the direct generation prompt is input into the NL2SQL model via the production subsystem for inference. The NL2SQL model then translates the natural language utterance into a SQL query. This translation process includes the NL2SQL model first parsing the natural language utterance to understand the user's intent. This involves identifying the key components of the request, such as the desired action (e.g., SELECT, UPDATE), the entities involved (e.g., tables, columns), and any conditions or filters. For example, if the user says, “Show me all the customers who signed up in the last month,” the model identifies the action (retrieve data), the entities (customers), and the condition (signed up in the last month). The NL2SQL model then maps the identified entities and conditions to the corresponding elements in the schema (e.g., database schema). This step needs knowledge of the database structure, including table names, column names, and data types (which is included within the direct generation prompt template). Continuing with the example, the model needs to know that “customers” refers to a specific table, and “signed up” corresponds to a column (e.g., ‘signup_date’) in that table. Using the parsed intent and mapped schema elements, the NL2SQL model constructs a syntactically correct SQL query. This involves selecting the appropriate SQL keywords and structuring the query according to SQL syntax rules. For the example request, the LLM would generate the following SQL query:

```
  “sql
  SELECT * FROM customers WHERE signup_date >= DATE_SUB(CURDATE( ),
INTERVAL 1 MONTH);
“
```

The NL2SQL model may then validate the constructed SQL query to ensure it aligns with the user's intent and adheres to the database schema. This could involve checking for syntax errors, ensuring the correct use of SQL functions, and verifying the query against the schema. If necessary, the NL2SQL model refines the query to better match the user's request or correct any identified issues. This step might also involve asking the user for clarification if the original utterance was ambiguous. Once generated and optionally validated, the NL2SQL model outputs the SQL queries at block 425.

At blocks 410 and 412, the SQL queries are executed on the corresponding database using a SQL engine (execution engine) to obtain execution results. The execution engine executes the SQL queries on a database by following a multi-step process that involves parsing, optimizing, and executing the query. Initially, an SQL query is parsed to create an internal representation, typically an Abstract Syntax Tree (AST), which outlines the structure of the query. The engine then consults the database schema to validate the query, ensuring that all referenced tables, columns, and data types exist and are correctly used. Once validated, the query undergoes optimization, where the execution engine determines the most efficient way to access and manipulate the data, often through the use of query optimization techniques such as indexing, join algorithms, and query rewriting. This step aims to minimize resource usage and execution time. Finally, the optimized query is executed against the database. The execution engine processes the query plan, retrieves the needed data from the storage engine, and applies any necessary transformations, such as filtering, sorting, or aggregating. The resulting data is then formatted and returned to the user (or user(s)) by way of production flow 417 or application that issued the query (block 414), completing the process of data retrieval.

To manage and maintain its performance, a deployed model such as the NL2SQL model may be continuously monitored to ensure it performs as expected over time. This involves tracking the model's inference accuracy, response times, and other operational metrics. Additionally, the model may need retraining or updates based on new data or changing conditions in the environment it is applied in. This can be useful because machine learning models can drift over time due to changes in the underlying data the models are making predictions on-a phenomenon known as model drift. Therefore, maintaining a machine learning model in a production environment often involves setting up mechanisms for performance monitoring, regular evaluations against new test data, and potentially periodic updates and retraining of the model to ensure it remains effective and accurate in making predictions.

### III. EXAMPLES OF GENERATIVE MODEL SENSITIVITY TO PHRASING

The description below pertains particularly to logical form queries related to SQL but it should be understood that any logical form query could be used without departing from the spirit and scope of the present disclosure.

Throughout this disclosure, the terms “SQL Query” and “SQL Queries” are used to describe a structured command or statement written in Structured Query Language (SQL) that is used to retrieve, manipulate, or manage data within a relational database. However, referencing SQL queries in this disclosure should not be considered limiting, and any suitable equivalent, including queries written in equivalent and/or similar languages or systems that perform equivalent and/or similar data operations, is anticipated within the scope of this disclosure.

Throughout this disclosure, the term “Gold Truth” or “Gold Truth Training Example” is used to describe a definitive and correct logical form query or data retrieval command and/or examples that serves as a benchmark or reference for evaluating the accuracy and efficiency of generated or predicted queries and/or examples within a database system. However, this definition should not be considered limiting, and any suitable equivalent, including alternative representations of reference queries, examples, or validation standards, is anticipated within the scope of this disclosure.

Throughout this disclosure, the term “Generative Model” is used to describe a computational system or algorithm designed to generate outputs, such as text, images, or code, based on learned patterns and relationships from training data, often employing techniques like neural networks or probabilistic modeling. However, this definition should not be considered limiting, and any suitable equivalent, including machine learning models utilizing different architectures or methodologies to produce generative outputs, is anticipated within the scope of this disclosure.

Throughout this disclosure, the term “Natural Language Utterance” is used to describe a spoken, signed (e.g., American/French/British Sign Language, etc.), or written expression in a human language, that conveys a user's intention or query and can be processed or interpreted by computational systems for tasks like translation, information retrieval, or conversational AI. However, this definition should not be considered limiting, and any suitable equivalent, including alternative forms of human language and/or equivalent machine language (or code) input or communication, is anticipated within the scope of this disclosure.

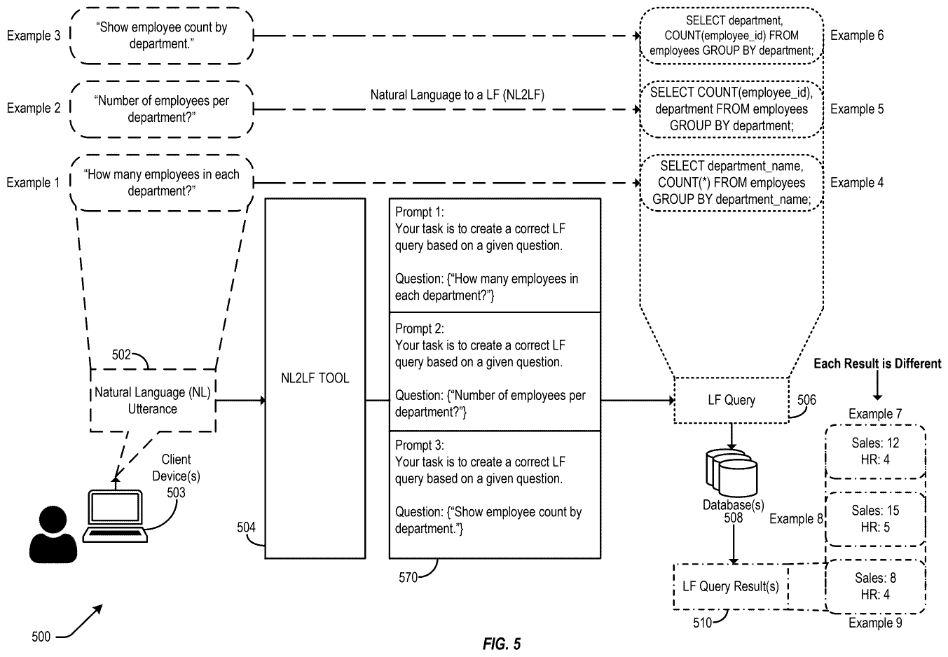

As described above in connection with FIGS. 1-3, generative models can translate natural language utterances into structured database queries, enabling users to interact with data systems through intuitive, conversational inputs. While these models help lower technical barriers to database access and enhance user productivity, their effectiveness relies on accurately capturing user intent and producing queries that are both syntactically and semantically correct for a target database's schema and formatting needs. When a generative model yields different results for user questions that are semantically identical but phrased differently, it can cause the database to return inconsistent or invalid results, generate errors, or even fail to execute the query altogether. Such inconsistencies undermine the reliability and practical value of the generative model. An example of these technical deficiencies is described with respect to FIG. 5.

FIG. 5 depicts a simplified diagram 500 for an example natural language to logical form tool translating a natural language utterance into a logical form. FIG. 5 depicts an example scenario as described above where multiple example NL utterances (e.g., examples 1-3) are provided to a NL2LF tool 504 (e.g., a chatbot). The multiple example NL utterances are three distinct, but semantically similar, questions are provided by client device(s) 503. In an ideal world, these three questions would always evaluate, when executed on a logical form database, to the same or similar SQL queries. However, as depicted, the NL2LF tool 504 generates and provides three separate prompts 570 to a generative model (not depicted) to evaluate by executing the results on a database. These example NL utterances do not have to be received at the same time and could be received, for example, over the course of weeks or even years. As shown, examples 1-3 do not translate to the same result, as shown in examples 4-6. Due to this, the LF queries 506, when executed on suitable database(s) 508, give different LF query result(s) 510 shown in examples 7-9.

Regarding, example 6, this query groups the data by the column department and counts the number of employee_id values in each group. The output will include two columns: department and the corresponding count of employees in each department. This assumes that every row in the employees table contains a valid department value and that employee_id is the correct unique identifier for employees. Regarding, example 7, the query performs the same logical grouping as the first query but changes the order of the output columns: the count appears first, followed by the department. Some SQL databases may accept this reversal, while others may need the grouping column to be first. Additionally, downstream systems expecting a specific column order might not parse the result as intended. Regarding example 6, this version uses department_name instead of department as the grouping column and counts all rows with COUNT( ) The use of COUNT( ) means all rows, including those where employee_id may be NULL, are counted. This can result in a higher count if there are rows for employees without assigned IDs. The example outputs (e.g., examples 7-9) for each query illustrate how subtle changes in query structure can lead to differences in the returned data, even when the user's intent is the same. In the first query, the output uses the column names department and a count of non-null employee_id values, producing results with these specific labels and potentially omitting rows with null IDs. The second query reverses the order of the output columns, listing the count before the department, which may not match the expectations of downstream systems or users. In the third query, grouping is performed by department_name and counting is done with COUNT(*), which includes all rows regardless of whether employee_id is present; this can result in higher counts if incomplete records exist. Furthermore, different naming conventions (e.g., department vs. department_name) and ordering can disrupt processing, reporting, or data integration.

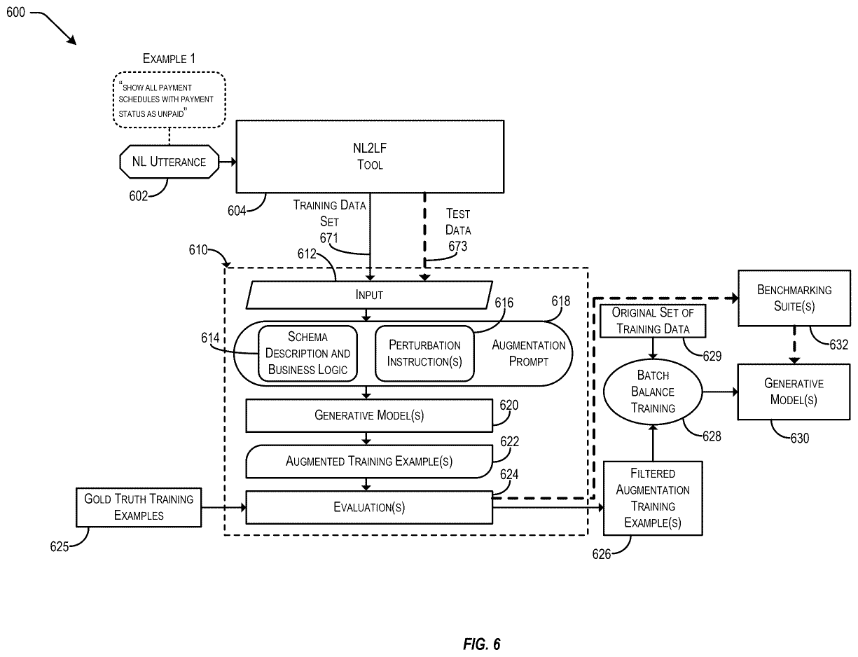

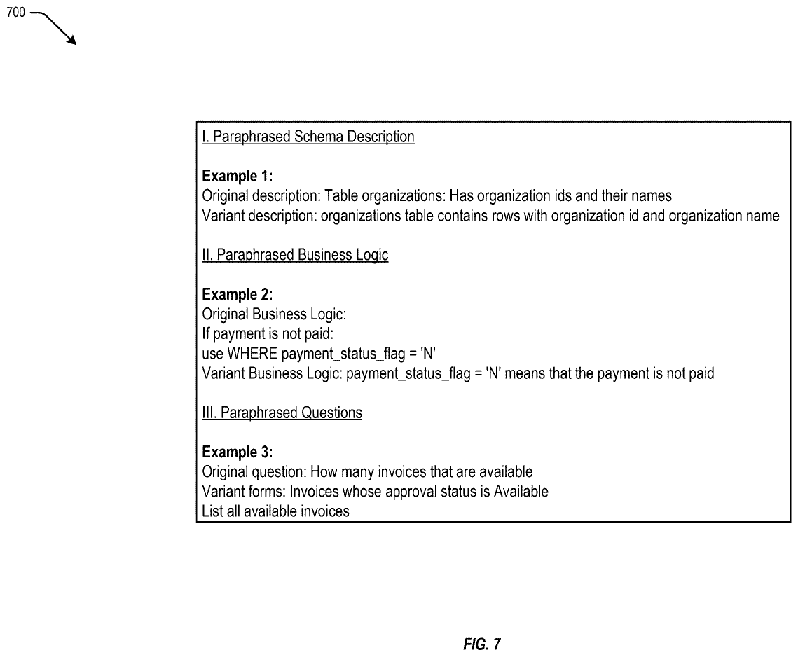

In a non-limiting example, suppose a database expects the first column to be the department name and the second column to be the employee count. If it receives a result with the columns reversed or with a different column name, the dashboard may display incorrect labels, misalign data, or even crash if it cannot parse the unexpected format. Similarly, if the counting logic includes or excludes certain rows based on NULL values or the grouping column is inconsistent, the reported numbers may not accurately reflect organizational reality, leading to poor decision-making. These examples demonstrate how semantically similar natural language requests can lead to queries that, while superficially similar, have important technical differences. The following description in FIG. 6, as well as example perturbations in FIGS. 7-14, will demonstrate an exemplary process to make the generative model more robust to these variations and generate queries which evaluate to the same results when executed on the databases.

### IV. EXAMPLE OF FINE-TUNING GENERATIVE MODELS TO BE ROBUST AGAINST VARIANT PHRASING

FIG. 6 depicts a simplified block diagram 600 for an example generative model fine-tuning computing environment comprising subsystems, repositories, and models, according to various embodiments. Each subsystem can be understood to include an execution of one or more processes and/or programs implemented with software, hardware, and/or firmware within a system (e.g., as described with respect to FIGS. 17-21). Moreover, it should be understood that the one or more processes and/or programs can be executed as part of an iterative process that ultimately generates content such as augmented training and/or testing data. Iteration or an iterative process being the process of repeating a set of instructions or steps multiple times or cycles. For example, a set of instructions or steps may be executed for augmented training and/or testing examples and repeatedly executing the set of instructions or steps multiple times or over multiple cycles results in augmented training and/or testing example sets. Each cycle of the set of instructions or steps may be executed serially, or multiple cycles of the set of instructions or steps may be executed in parallel.

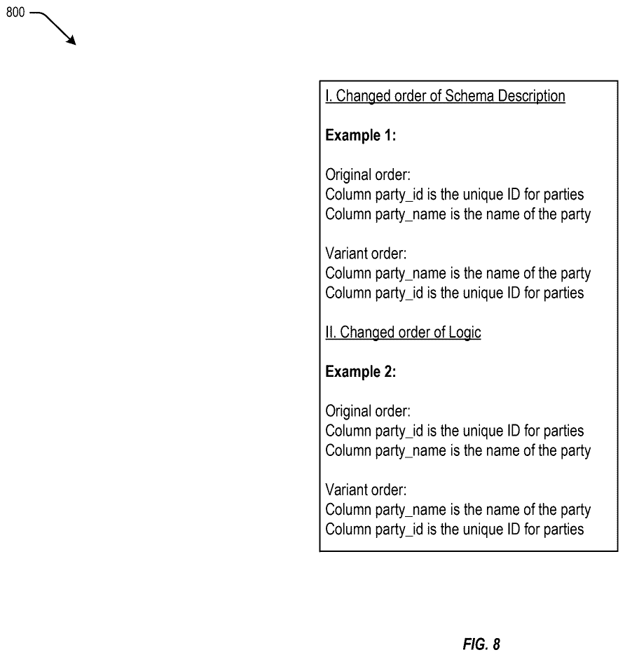

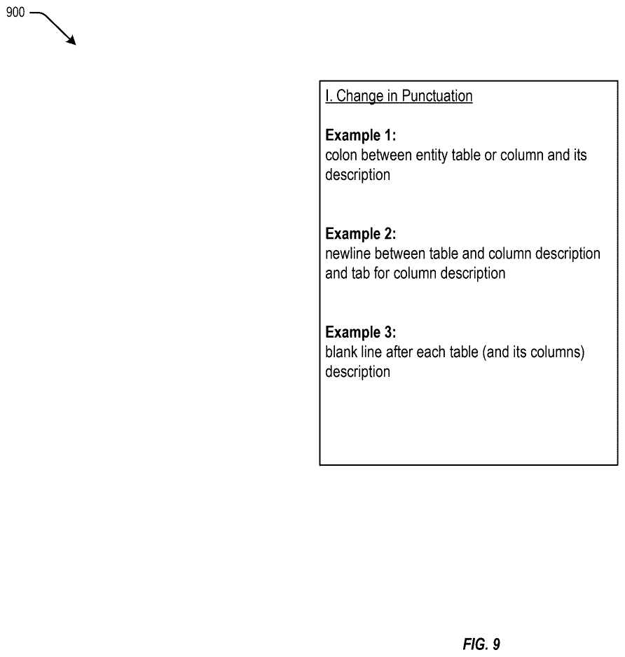

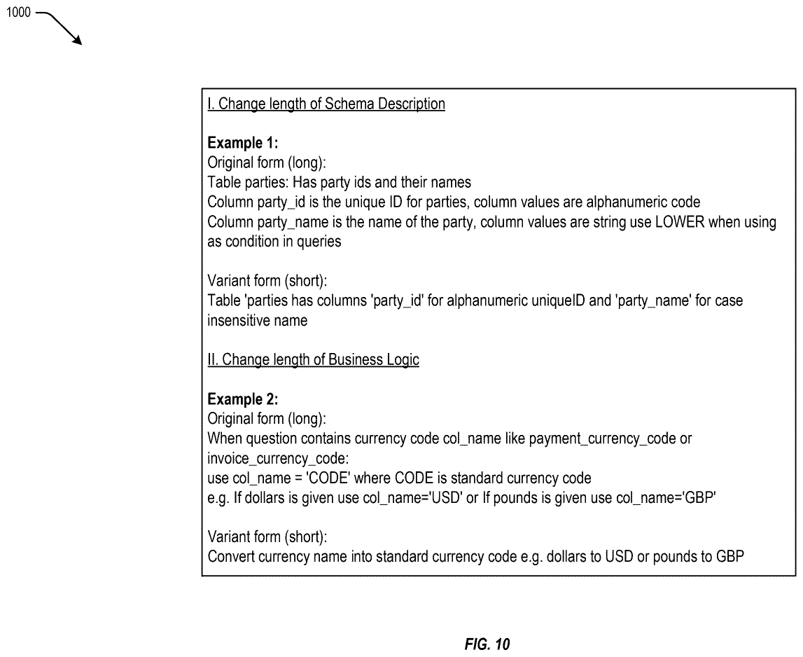

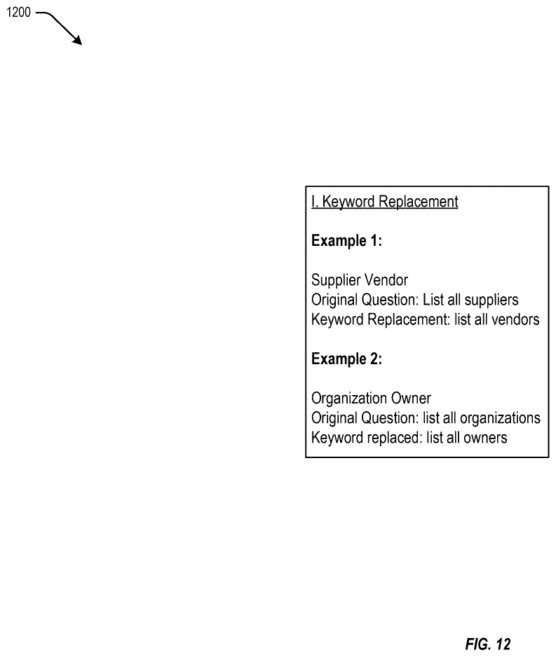

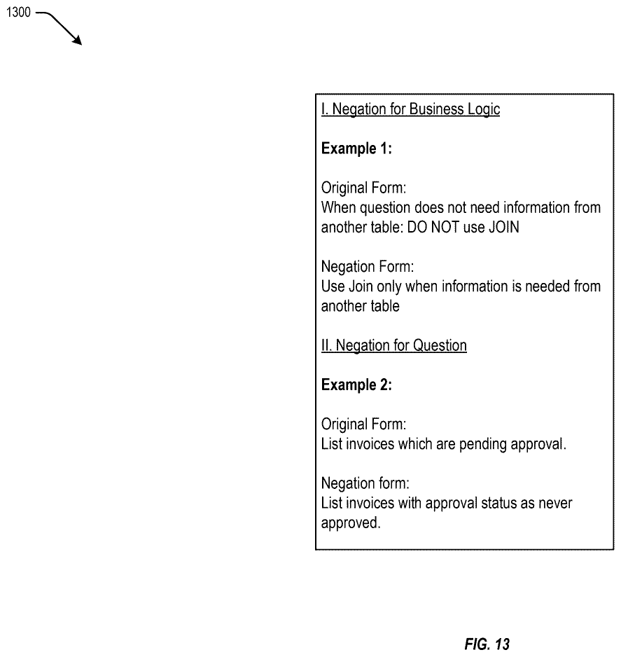

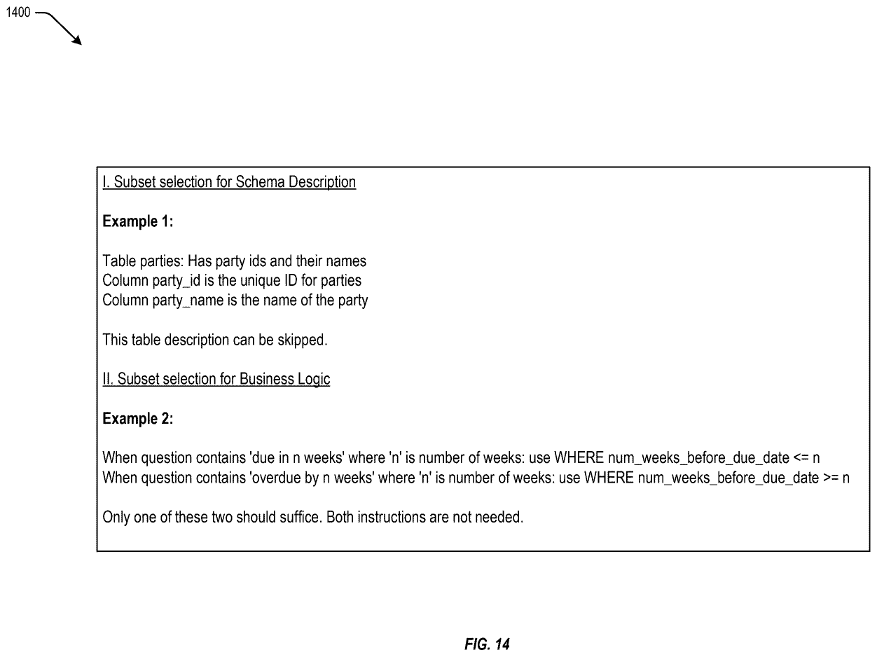

By way of a non-limiting example, a training data set 671 may be provided as input 612 into a pipeline 610 which may be an iterative pipeline for augmenting training data sets (and/or test data sets). The training data set 671 may include training examples that include a prompt having a NL utterance, database schema, and/or business logic. In some examples, the prompt includes an instruction for translating a natural language utterance to a structured query language instruction, the natural language utterance (e.g., translate the natural language utterance to a different semantically similar natural language utterance), a database schema, and/or a business logic instruction. The natural language utterance may be included with the structured query language instruction, the database schema, and/or the business logic instruction. In some examples, the training data set 671 may not include a prompt or be included in a prompt. The training data set 671 may include examples of variant forms in a set of categories including, without limitation, paraphrasing examples (as in FIG. 7), change in order examples (as in FIG. 8), punctuation examples (as in FIG. 9), a change in length examples (as in FIG. 10), a direct form change examples (as in FIG. 11), a keyword replacement examples (as in FIG. 12), negation examples (as in FIG. 13), subset selection examples (as in FIG. 14), or any combination thereof. Each of these examples will be discussed in more detail later.

The training data set 671 may be inducted (or otherwise added) into an augmentation prompt 618 to be provided to one or more generative model(s) 620. In some examples, the generative model(s) 620 may be pre-trained. The augmentation prompt 618 may include schema descriptions and business logic 614 and/or perturbation instructions 616. The perturbation instruction(s) 616 may include instructions to generate variant forms of instructions based on the set of categories for one or more NL utterances 602.

For example, for a given original schema description in the training data set 671, “This is the schema description of a database: {Original Schema_description0}, the instructions for the category of paraphrasing (as in FIG. 7) may be: “Modify the schema description and give a paraphrased form. Do not change the given tables or column names. Do not add any new information. Do not skip any information already present in the schema description. Change each sentence in the schema description by rephrasing but keep the meaning same.”

In another example, for a given business logic description, “This is the Business Logic related for creating a SQL for an existing database: {Original Business Logic}”, the instructions for paraphrasing (as in FIG. 7) may be: “Modify the business logic and give a paraphrased form. Do not change the given tables or column names. Do not add any new information. Do not skip any information already present in the business logic. Change each sentence in the business logic by rephrasing but keep the meaning same”.

The augmentation prompt 618 may be provided to the generative model(s) 620 in order to instruct the generative model(s) 620 to produce one or more augmented training example(s) 622 that are to be evaluated. The augmented training example(s) 622 include logical forms of the associated utterance(s) from the training data set 671 which have been perturbed by the generative model(s) 620 in accordance with perturbation instruction(s) 616 in the augmentation prompt 618.

One or more evaluation(s) 624 may be performed by the NL2LF tool 604, one or more generative models (and/or generative model(s) 620), or by humans on the augmented training example(s) 622 as compared to one or more gold truth training examples. By way of a non-limiting example, generative models can be employed as evaluators serving the roles of a judge, jury, or both to assess the quality and correctness of the generative model(s) 620. This evaluation may use a comparison between the augmented training example(s) 622 and one or more gold truth examples 625 which include utterances that include variant forms that have been pre-evaluated to return the same results. The judge/jury generative model(s) may receive as input the augmented training example(s) 622, the corresponding gold truth training example(s) 625, and optionally additional context such as the original query, schema definitions, or business logic.

Upon receiving the augmented training example(s) 622, the judge/jury generative model(s) can apply a set of decision criteria, which may be predefined, learned through training, and/or dynamically adjusted, to determine the degree of alignment between the augmented training example(s) 622 and the gold truth training examples 625. The evaluation(s) may involve semantic similarity analysis, syntactic comparison, logical equivalence checks, or other relevant metrics. In some embodiments, the judge/jury generative model(s) renders a binary judgment (e.g., pass/fail, match/mismatch), assigns a confidence score or rank, and/or provides a qualitative explanation for the decisions. Where multiple augmented training example(s) 622 are provided during the process (e.g., one-off, iterative, etc.), the judge/jury generative model may act as a jury, aggregating judgments across several instances to reach a consensus or majority verdict. In some examples, outputs from each step in the process may be aggregated and provided to the judge/jury for evaluation(s) 624.

Using judge/jury generative model(s) as impartial and consistent evaluators, the NL2LF tool 604 can reduce the need for manual review and subjective interpretation by human assessors increasing the efficiency, scalability, and objectivity of the evaluation process. The use of gold truth training examples 625 ensures that the assessment is grounded in established standards of correctness, supporting validation of generative model outputs in training, benchmarking (discussed at 632), and/or production environments. In some examples, the evaluation(s) 624 can be used iteratively to refine and optimize candidate models, facilitate active learning workflows, and/or support continuous integration and deployment pipelines. In various implementations, the judge/jury generative model's judgments can be logged, audited, or explained to provide transparency and traceability for compliance or quality assurance purposes.

In various embodiments, human evaluators may be employed (alternatively or in addition to the judge/jury generative model(s)) to assess the quality and correctness of augmented training example(s) 622 by comparing these augmented training example(s) 622 to one or more gold truth examples 625. In this approach, human judges or panels of evaluators receive the augmented training example(s) 622, the corresponding gold truth training example(s) 625, and any relevant contextual information, such as the original query, schema definitions, or applicable business logic. The human evaluators then apply predetermined assessment criteria, which may include semantic similarity, syntactic accuracy, logical consistency, or compliance with domain-specific needs, to determine the degree of alignment between the candidate output and the gold truth examples 625. The results of evaluation(s) 624 may be recorded as binary judgments (e.g., correct/incorrect), ranked scores, or qualitative feedback, and in cases involving multiple evaluators, aggregated to reflect consensus or majority opinion.

As a result of the evaluation(s) 624, only augmented training example(s) 622 that satisfy the evaluation(s) 624 are retained, while all other augmented training example(s) 622 are systematically excluded from the final result set. After augmented training example(s) 622 are compared against gold truth training examples 625 or assessed according to domain-specific validation rules, any augmented training example(s) 622 that aligns with the intended semantic meaning, syntactic accuracy, and logical form structure that evaluates to an appropriate logical form (e.g., query) is accepted as a correct result. Augmented training example(s) 622 that do not meet these criteria, whether due to inconsistency, inaccuracy, or failure to conform to expected standards, are removed or flagged for further review. By removing examples from the augmented training example(s) 622, filtered augmentation training example(s) 626 may be generated and used for fine-tuning generative model(s).

In various embodiments, filtered augmentation training example(s) 626 that have passed evaluation(s) 624 are integrated with the original set of training data 629 to perform batch balance training 628 of generative model(s) 630. The inclusion of these filtered augmentation training example(s) 626 serves to reinforce the generative model's 630 exposure to exemplary responses that meet established correctness criteria. This batch balance training 628 is advantageous where the original set of training data 629 may not capture a full diversity of real-world user expressions or domain-specific needs. The original set of training data 629 may include queries like “Show total sales for last month,” mapped to appropriate SQL statements. During deployment, however, users might phrase similar requests as, “How much did we sell last month?” or “Total revenue in the previous month?” If the generative model(s) 620 generates correct SQL queries for some of these variants and they are validated through the evaluation(s) 624, these filtered augmentation training example(s) 626 can be added to the original set of training data 629.

Moreover, integrating filtered augmentation training example(s) 626 into batch balance training 628 allows for systematic coverage of edge cases and rare expressions that may not be well represented in the original data. During batch balance training 628, batches are constructed to promote a balanced mix of linguistic forms, semantic equivalence, and/or complexity levels. This includes various paraphrases, reordered instructions, and queries with differing punctuation or verbosity, all mapped to the same structured output. As the generative model(s) 630 is exposed to this diversity, the generative model(s) 630 learns to focus on semantic intent rather than semantic linguistic differences fostering invariance to paraphrasing and other variations. Returning to the process, as new user NL utterances and their validated filtered augmentation training example(s) 626 are encountered they may be incorporated into the original set of training data 629.

In various embodiments, the pipeline 610 may be used for benchmarking generative model(s) 630 by way of test data 673 and benchmarking suite(s) 632. The benchmarking suite(s) 632 may evaluate the performance and robustness of the generative model(s) 630, particularly in its ability to handle a wide range of linguistic and structural variations. To establish a baseline, test data 673 is selected, containing representative test examples that cover the core tasks expected of the generative model(s) 630. In some examples, the test data 673 is provided as input into the pipeline and may include natural language utterances. The prompt may include an instruction for translating, for the test examples, a natural language utterance to a structured query language instruction, the natural language utterance (e.g., translate the natural language utterance to a different semantically similar natural language utterance), a database schema, and/or a business logic instruction. The natural language utterance may be included with the structured query language instruction, the database schema, and/or the business logic instruction. For each type of perturbation (e.g., paraphrasing, reordering, punctuation changes, verbosity adjustments, keyword substitutions, or multi-part instruction extraction), a comparable number of perturbed examples (e.g., one hundred and fifty examples or greater) is generated so that every category is equally represented. In this example, a number of distinct test categories (e.g., eight, one for each category) are defined, each corresponding to a specific perturbation type, resulting in test data 673. For instance, one test example may contain paraphrased queries (e.g., “Show revenue for Q1” changed to “For the first quarter, display revenue”), another test example may focus on reordered instructions (e.g., “Exclude inactive users and list all customers” versus “List all customers, excluding inactive users”), while others may address altered punctuation, increased or decreased verbosity, or changes to the underlying keywords used in the prompt.

In various embodiments, for perturbations applied solely to the user NL utterances 602, the benchmarking suite 632 may be diversified by applying similar perturbations to other important components such as schema descriptions and business logic statements. This means that, in addition to the eight perturbation categories applied to the NL utterances 602, additional test examples are created where schema descriptions or business logic are individually perturbed in parallel ways. For example, a schema description might be rewritten to use synonyms or reordered fields, and business logic might be expressed using alternative terminology or rephrased constraints. Altogether, this systematic approach produces a number of test examples (e.g., fifteen), a subset (e.g., eight) for the different question perturbation types, and a second subset (e.g., seven) more for the analogous variations applied to schema descriptions and business logic. In some examples, test data 673, containing the test examples, may exclude the original set of training data 629. As an alternative or addition, the benchmarking suite(s) 632 can be further enhanced by including hybrid test examples that combine multiple perturbation types within a single example, or by incorporating domain-specific edge case test examples and adversarial test examples to stress-test the generative model′(s) 630 robustness.

In various embodiments, a match metric is employed to quantitatively assess the accuracy of the generative model(s) 630 in translating NL utterances 602 into structured outputs (e.g., as SQL queries). The function of this match metric is to determine whether the execution results of the generative model(s) 630 generated queries are consistent with a gold standard result for each test case, regardless of how NL utterance 602 is phrased. This approach isolates generative model(s) 630 accuracy from linguistic variability focusing solely on the correctness of the final output as measured against authoritative, predefined answers. The match metric can be applied at various stages of generative model(s) 630 development, including before, during, and/or after batch balance training, as well as in conjunction with the benchmarking suite(s) 632. For example, if an example generative model is presented with the prompt “List all overdue invoices,” the match metric would compare the result of the generated SQL query against the gold result for that query providing a binary or scalar score that reflects whether the generative model's 630 output is functionally equivalent to the intended answer. The match metric provides an objective measure of the generative model(s) 630 performance in providing correct results across a spectrum of examples.

In various embodiments, an invariance metric is used to evaluate the robustness of generative model(s) 630 by measuring its ability to produce consistent outputs under varied input conditions. Specifically, the invariance metric assesses whether the generative model(s) 630 yields the same or equivalent results when presented with different forms of the same prompt, or when perturbations are introduced to related components such as schema descriptions, business logic, or database values. For instance, if one training example contains the base question “Show sales by region,” and another applies a perturbation such as paraphrasing (“Display regional sales”), the invariance metric examines whether the generative model(s) 630 produces outputs that are invariant. This means that the execution results remain consistent across these variants. This evaluation may be dependent on the match metric, as the base (unperturbed) result serves as a reference for comparison. When two or candidate generative model(s) 630 achieve similar match metrics, the generative model(s) 630 with the higher invariance metric is preferred, as it demonstrates superior robustness to real-world linguistic and contextual variability compared to the other generative model(s) 630.

In various embodiments, using one or both of the match and invariance metrics, a determination may be made on whether the generative model(s) 630 are sufficiently trained and ready for deployment in a production environment. The match metric ensures that the generative model(s) 630 reliably produces correct results for canonical test cases, establishing a baseline level of functional accuracy. The invariance metric supplements this by confirming that the generative model(s) 630 maintain accuracy across a wide range of input perturbations, which is important for robust performance in diverse operational settings. In practice, generative model(s) 630 training and fine-tuning may continue iteratively until both metrics reach predetermined threshold (e.g., a desired percentage of correct matches and a high degree of invariance across all perturbation categories). When improvements to either metric plateau or when both metrics meet or exceed target values, this signals that the generative model(s) 630 have achieved an optimal balance of accuracy and robustness, and that further training is unlikely to yield significant benefits.

### V. VARIANT PHRASING EXAMPLES

In the following description, eight distinct categories of perturbations are described, each designed to introduce a variant form of an input. These categories encompass paraphrasing (e.g., where the original prompt is restated using different wording), reordering (e.g., altering the sequence of instructions or clauses), punctuation changes (e.g., modifying commas, periods, or other marks), verbosity adjustments (e.g., increasing or decreasing the length or detail of the prompt), keyword substitutions (e.g., replacing critical terms with synonyms or domain-equivalent language), multi-part instruction extraction (e.g., isolating or combining instructions from complex queries), schema description modifications (e.g., rewording or restructuring database schema information), and business logic alterations (e.g., restating or varying the logical constraints). Each category is systematically applied to generate variant forms that challenge the model's ability to maintain consistent and correct output across a spectrum of real-world linguistic and contextual scenarios. It should be understood that these eight categories, and the specific examples provided for each, are merely illustrative; additional types, subcategories, or combinations of perturbations may be employed as appropriate to further evaluate or stress-test generative model's performance, and the scope of these embodiments is not limited to the particular perturbation strategies described herein.

FIG. 7 depicts a simplified diagram for example paraphrasing perturbations, according to various embodiments. Paraphrase perturbation may involve restating an original description using different language while preserving the underlying meaning. This category is intended to test whether the generative model can recognize and act on varied phrasings of the same intent. For schema descriptions, a paraphrase might change “The ‘orders’ table records all purchase transactions” to “Purchase transactions are captured in the orders table.” For business logic, “Exclude orders that are cancelled” can be paraphrased as “Do not include any cancelled orders.” In NL utterances, “List all customers from New York” might be restated as “Show customers who are based in New York.” These variant forms ensure the generative model(s) is not dependent on a specific wording and can handle real-world linguistic diversity.

As depicted, for schema descriptions, the original form “Table organizations: Has organization ids and their names” might be paraphrased as “Organizations table contains rows with organization id and organization name.” In business logic, the original instruction “If payment is not paid: use WHERE payment_status_flag=‘N” can be paraphrased as “payment_status_flag=‘N’ means that the payment is not paid.” For natural language utterances, the original question “How many invoices that are available” may be reworded as “Invoices whose approval status is Available” or “List all available invoices.” Each variant tests whether the generative model(s) can map different expressions to the same database logic or output.

FIG. 8 depicts a simplified diagram for example change in order perturbations, according to various embodiments. Change in order perturbation alters the sequence of elements or clauses in the input, without changing the logical meaning. These examples are used to verify that the generative model is invariant to the order in which information is presented. For schema descriptions, “The users table has fields: name, email, and phone” can be reordered to “Phone, name, and email are fields in the users table.” In business logic, “Apply discount, then calculate total” can be reordered as “Calculate total after applying discount.” For NL utterances, “First, filter by active users, then sort by sign-up date” might become “Sort by sign-up date after filtering for active users.” The generative model is tested for its ability to process instructions irrespective of their order.

As depicted, a schema description where the original order is “Column party_id is the unique ID for parties. Column party_name is the name of the party.” The variant order would be “Column party_name is the name of the party. Column party_id is the unique ID for parties.” Similarly, for business logic, the ordering of logic statements can be swapped without changing the meaning. For questions or utterances, if a user's request changes the order of information, the generative model should still produce the correct output. These variants evaluate the generative model(s) ability to function independently of the order in which data or instructions are presented.

FIG. 9 depicts a simplified diagram for example punctuation perturbations, according to various embodiments. Punctuation perturbation involves modifying, adding, or removing punctuation marks in the input. Using these examples tests the model's robustness to punctuation differences that commonly arise in natural communication. For schema descriptions, “The ‘order_id’, ‘customer_id’, and ‘amount’ fields are indexed.” may be punctuated as “The order_id customer_id and amount fields are indexed.” In business logic, “If payment is overdue, apply a late fee.” becomes “If payment is overdue apply a late fee.” For NL utterances, “Show orders placed after March 1; exclude cancelled orders.” could be changed to “Show orders placed after March 1 exclude cancelled orders.” This category ensures the generative model(s) is resilient to punctuation inconsistencies.

This category is demonstrated by variant forms in punctuation for schema descriptions, such as “Table poz_suppliers_testdata: Has suppliers data” using a colon, or providing column descriptions on new lines with tabs: “Table poz_suppliers_testdata: Has suppliers data
“\*MERGEFORMAT\*MERGEFORMAT Column vendor_name is the name of the vendor.” A further variant form might include a blank line after each table and column description, testing whether the model's output remains correct despite formatting changes. The same principle applies to business logic and user questions, where punctuation may be altered or omitted.

FIG. 10 depicts a simplified diagram for example change in length perturbations, according to various embodiments. Change in length perturbation either expands or contracts the detail or verbosity of the input. These examples are used to determine if the generative model(s) are robust to both brief and elaborated instructions while preserving accuracy. For schema descriptions, a verbose form may be “The orders table contains the fields: order_id, customer_id, item_id, quantity, price, and order_date, all of which are needed,” while a short form is “Orders table: id, cust_id, item, qty, price, date.” In business logic, “Exclude any items that are marked as returned, damaged, or cancelled before summing the order total” can be shortened to “Exclude returned items.” For natural language utterances, “List all employees” might be expanded to “Provide a complete list of all employees currently employed by the organization, regardless of department or tenure,” or shortened to “Show staff.” This perturbation checks if the model's performance is consistent across varying input lengths.

As depicted, the original long form “Table parties: Has party ids and their names. Column party_id is the unique ID for parties, column values are alphanumeric code. Column party_name is the name of the party, column values are string use LOWER when using as condition in queries” can be shortened to “Table ‘parties’ has columns ‘party_id’ for alphanumeric uniqueID and ‘party_name’ for case insensitive name.” In business logic, a verbose rule like “When question contains currency code col_name like payment_currency_code or invoice_currency_code: use col_name=‘CODE’ where CODE is standard currency code, e.g. If dollars is given use col_name=‘USD’ or If pounds is given use col_name=‘GBP” might be shortened to “Convert currency name into standard currency code, e.g. dollars to USD or pounds to GBP.” This ensures the generative model(s) responds accurately regardless of input length.

FIG. 11 depicts a simplified diagram for example direct form change perturbations, according to various embodiments. Direct form change perturbation modifies the structure or grammatical form of the input without altering its intent. This includes changing from a statement to a question, using passive instead of active voice, or switching declarative to imperative form. For schema descriptions, “The table orders includes a customer_id” may be rephrased as “Customer_id is included in the orders table.” In business logic, “The system should not allow duplicate entries” can be changed to “Duplicate entries are not allowed by the system.” For natural language utterances, “Show revenue by region” may be rephrased as “Revenue by region should be shown.” This category evaluates the generative model(s) flexibility to structural variations.

As depicted, a direct form in business logic might be “If payment is unpaid: use WHERE payment_status_flag IN (‘N’, ‘P’).” The indirect form could be “Unpaid could be completely not paid or partially paid.” For schema descriptions, a direct statement might be “Table includes a customer_id,” while an indirect form could be “There is a field for customer identification in the table.” For questions, a direct command like “List all available invoices” could be rephrased as “Available invoices should be listed.” This tests the generative model(s) ability to interpret both direct and indirect formulations.

FIG. 12 depicts a simplified diagram for example keyword replacement perturbations, according to various embodiments. Keyword replacement perturbation substitutes key terms with synonyms or functionally equivalent words. This approach tests the model's semantic understanding and vocabulary range. For schema descriptions, “The ‘customer’ table” could be replaced with “The ‘client’ table.” In business logic, “Flag unpaid invoices” might be restated as “Mark outstanding bills.” For NL utterances, “Get employee salaries” can be changed to “Retrieve staff compensation.” By introducing synonyms or equivalent terms, this category checks whether the model can correctly interpret intent despite changes in terminology.

As depicted, an example involves replacing key terms in schema descriptions, such as substituting “Supplier” with “Vendor”, the schema description “Table suppliers: Contains supplier details” becomes “Table vendors: Contains vendor details.” In business logic, “Flag overdue invoices” could become “Mark late bills.” For NL utterances, the original question “List all suppliers” could be changed to “List all vendors,” or “List all organizations” could be altered to “List all owners.” This type of perturbation ensures the generative model(s) outputs are correct even when synonyms are used.

FIG. 13 depicts a simplified diagram for example negation perturbations, according to various embodiments. Negation perturbation introduces or removes negation in the input, altering positive statements to negative or vice versa. This category is important for assessing the generative model's precision in handling instructions that need or prohibit specific actions. For schema descriptions, “Each order must be linked to a customer” might have a negation form “Orders are not needed to be linked to a customer if created as drafts.” In business logic, “Do not include inactive accounts” is the negation of “Include only active accounts.” For NL utterances, “List customers who have not placed an order this year” is a negation variant of “List customers who have placed an order this year.” Another example is, if the original instruction is “When question does not need information from another table: DO NOT use JOIN,” a negation form is “Use JOIN only when information is needed from another table.” This category ensures the generative model(s) accurately processes the presence or absence of negation.

As depicted, an example is in business logic, where the original form “When question does not need information from another table: DO NOT use JOIN” has a negation form “Use JOIN only when information is needed from another table.” For questions, the original “List invoices which are pending approval” could be negated as “List invoices with approval status as never approved.” For schema descriptions, “Product must have a price” could be negated as “Product may not have a price if it is a complimentary item.” These variants assess the generative model(s) ability to accurately respond to instructions involving logical negation.

FIG. 14 depicts a simplified diagram for example subset selection perturbations, according to various embodiments. Subset select perturbation focuses on extracting or targeting specific elements, ranges, or conditions from within a broader input. This tests the generative model(s) ability to correctly interpret and implement selective criteria. For schema descriptions, “The tasks table tracks all assignments, with start date, due date, and completion status” can be subset-selected as “Show only the due date field from the tasks table.” In business logic, “Apply discount to all orders over $500 and free shipping to those over $1000” can be subset-selected as “Apply discount to orders over $500.” For natural language utterances, “Show invoices due in n weeks” can be specified as “Use WHERE num_weeks_before_due_date=n.” This category ensures the model can accurately interpret instructions that need focusing on a specific subset or condition within a larger context.

As depicted, subset selection can be illustrated by schema descriptions like “Table parties: Has party ids and their names. Column party_id is the unique ID for parties. Column party_name is the name of the party.” A subset selection might focus only on “Column party_id is the unique ID for parties.” In business logic, the rule “When question contains ‘due in n weeks’ where ‘n’ is number of weeks: use WHERE num_weeks_before_due_date=n.” For questions, “Show invoices due in 2 weeks” versus “Show invoices overdue by 2 weeks” each need subset selection logic. This ensures the generative model(s) can accurately parse and respond to partial or conditional instructions.

### VI. EXAMPLE FINE-TUNED GENERATIVE MODEL ROBUST TO VARIANT PHRASING

Generative models trained as described above have undergone batch balance training and evaluation using match and invariance metrics demonstrate strong robustness to a range of variant forms as described with respect to FIGS. 7-14. By iteratively exposing these generative models to diverse linguistic expressions, reordered instructions, punctuation changes, variations in length, alternative formulations, keyword substitutions, negation, and subset selection during batch balance training and benchmarking, the generative models learn to generalize beyond the original training datasets. The match metric ensures consistent correctness of outputs, while the invariance metric validates accuracy even when inputs are rephrased or perturbed. The generative model(s) discussed below are reliable, adaptable, need less user intervention, and are well-suited for integration into production environments. These generative models, as discussed below, are robust to phrasing variations and may consistently deliver accurate and stable outputs across varied real-world scenarios, providing significant technical advantages and benefits for enhanced user experiences.

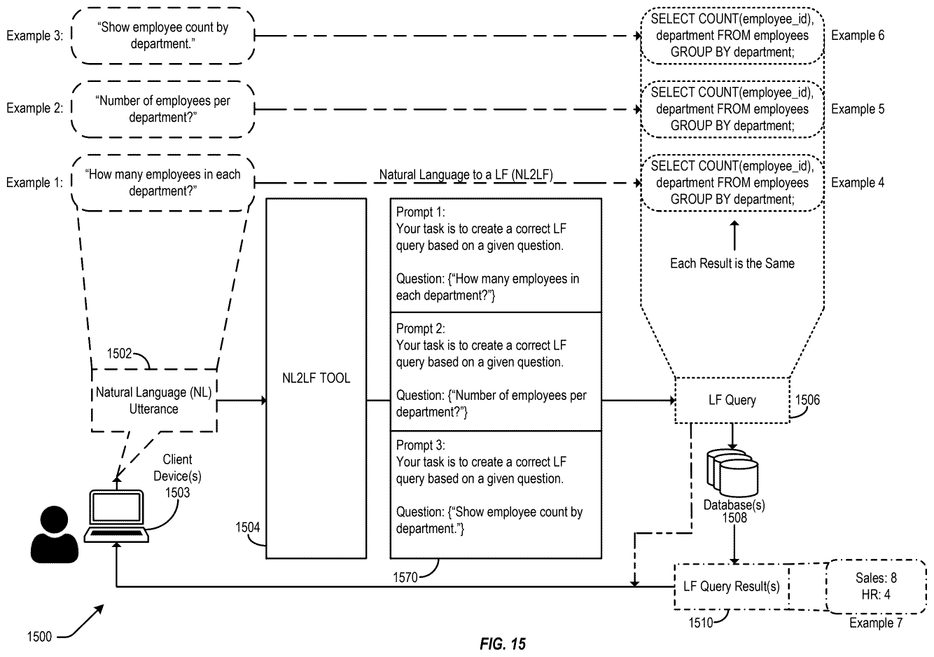

FIG. 15 depicts a simplified diagram for an example NL2LF process with different inputs resulting in similar outputs, according to various embodiments. FIG. 15 depicts an example scenario where multiple example NL utterances (e.g., examples 1-3) are provided to a NL2LF tool 1504 (e.g., a chatbot). The multiple example NL utterances are three distinct, but semantically similar, questions are provided by client device(s) 1503. The NL2LF tool 1504 generates and provides three separate prompts 1570 to a generative model (not depicted) to evaluate by executing the results on a database. These example NL utterances 1502 do not have to be received at the same time and could be received, for example, over the course of weeks or even years. As shown, examples 1-3 do translate to the same result, as shown in examples 4-6. Due to this, the LF queries 1506, when executed on suitable database(s) 1508, give the same LF query result(s) 1510 shown in example 7.

### VII. EXAMPLE METHODS FOR FINE-TUNING GENERATIVE MODELS

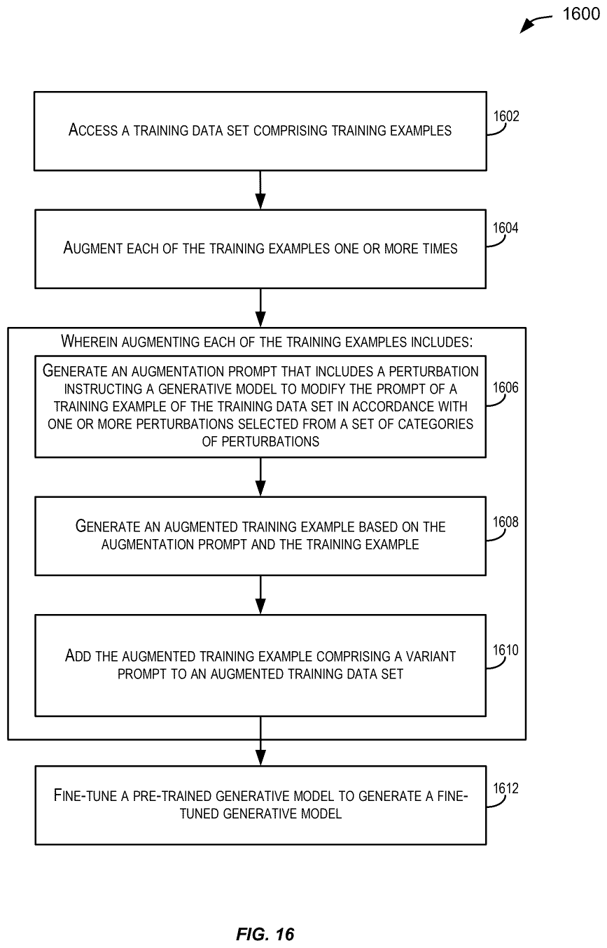

FIG. 16 depicts a simplified flow diagram for an example generative model fine-tuning process, according to various embodiments. The processing depicted in FIG. 16 may be implemented in software (e.g., code, instructions, a program) executed by one or more processing units (e.g., one or more processors, cores) of the respective systems, hardware, or combinations thereof described throughout. The software may be stored on a non-transitory storage medium (e.g., on a memory device). Although the methods presented in FIG. 16 depict the various processing steps occurring in a particular sequence or order, this is not intended to be limiting. In certain alternative embodiments, the steps may be performed in parallel and/or in a different order. In certain embodiments, such as in the embodiments depicted in FIGS. 1-12, the processing depicted in FIG. 16 may be performed by a NL2SQL tool and/or a NL2LF tool, as described with respect to FIGS. 1-6.

At 1602, a training data set (e.g., training data set 671 with respect to FIG. 6) comprising training examples may be accessed. By way of a non-limiting example, each training example in the data set may include a prompt that includes a NL utterance (e.g., NL utterance 602 with respect to FIG. 6) alongside a corresponding database schema. For example, a training instance might pair the NL utterance “List all customers who placed an order in the last month” with a schema description such as “Table: orders; Columns: order_id, customer_id, order_date.” Another instance could involve the prompt “Show employee names and hire dates” along with the schema “Table: employees; Columns: employee_id, employee_name, hire_date.” The data set is curated to represent a diverse array of utterances and schema configurations, ensuring broad coverage of the linguistic and structural variations that occur in practical database interactions.

At 1604, each of the training examples may be augmented one or more times (as in the pipeline 610). Augmenting may generate multiple variant forms for each training example increasing the diversity and robustness of the training data. For instance, a base example such as “Find all suppliers from California” might be transformed into variants like “Show all vendors located in California” or “List suppliers whose address is in California.” Through each augmentation, different types of perturbations are applied, resulting in a training set that reflects the variety of ways users might express similar requests or reference database schema elements.

At 1606, an augmentation prompt that includes a perturbation may be generated instructing a generative model to modify the prompt of a training example of the training data set in accordance with one or more perturbations selected from a set of categories of perturbations. By way of a non-limiting example, an augmentation prompt specifies how to modify the prompt of a training example using one or more perturbation categories. Generating the augmentation prompt (e.g., augmentation prompt 618) can involve altering the NL utterance, the database schema, or both (e.g., as in 614). Perturbation categories include paraphrasing, such as restating “Show all overdue invoices” as “List invoices that are overdue”; change in order, for example, reordering “List customers and their orders” to “Show orders and the associated customers”; punctuation changes, like modifying “List: customers, orders, and payments.” to “List customers orders and payments”; changes in length, either expanding “List users” to “Provide a comprehensive list of all registered users in the system” or contracting longer prompts; direct form changes, such as altering “Retrieve products that are in stock” to “Products in stock should be retrieved”; and keyword replacements, for example, changing “employees” to “staff” in “List all employees.” The resulting variant prompt may include any combination of these modifications, applied to the utterance, the schema, or both.

At 1608, an augmented training example (e.g., augmented training example(s) 622 with respect to FIG. 6) may be generated based on the augmentation prompt and the training example. Using the augmentation prompt, the generative model produces an augmented training example that reflects the instructed perturbation. For instance, given a base prompt “List customers with unpaid invoices” and an augmentation prompt for paraphrasing, the model might generate “Show all clients whose invoices are outstanding.” If a punctuation perturbation is applied, the prompt might become “List customers with unpaid invoices” without any special punctuation. This process is repeated for each perturbation category, resulting in a set of augmented examples that cover various linguistic and structural variants.

At 1610, the augmented training example comprising a variant prompt may be added to an augmented training data set. Each new augmented training example, featuring a variant form of the original prompt, may be incorporated into the augmented training data set. This expanded data set, which includes both original and augmented examples, supports the development of a generative model that learns to handle a broad spectrum of input variations. For example, a single original prompt may produce variant examples such as “Show overdue invoices,” “List all invoices that are past due,” and “Invoices past their due date should be listed,” all within the same schema context.

At 1612, a pre-trained generative model may be fine-tuned to generate a fine-tuned generative model. Fine-tuning uses both the original set of training data and filtered augmented training examples, enabling the generative model to robustly translate natural language utterances to structured query language (SQL) instructions. During fine-tuning, a test data set may also be accessed, with each test example containing a NL utterance and a database schema. These test examples may be augmented using iterative perturbation. For example, a test example containing a natural language utterance “Find all orders above $1000” might be augmented to “Show orders greater than one thousand dollars” or “Display all orders where the total exceeds $1000,” while the schema may be modified by reordering or renaming fields. The generative model processes these augmented test examples, and its outputs are evaluated for correctness and robustness using metrics such as the match metric, which measures whether the generated SQL produces the correct execution result, and the invariance metric, which assesses consistency across perturbed variants. This evaluation may be performed alongside batch balancing, ensuring each training batch contains a mix of original and augmented training examples from all perturbation categories.

Invalid or low-quality augmented training examples are filtered out, resulting in a filtered augmented training data set composed of only validated, high-quality examples. The fine-tuned generative model is then further trained or adjusted based on this filtered set to improve both accuracy and robustness. After this process, the generative model, now fine-tuned, is capable of receiving a NL utterance from a user, generating a programming language instruction such as a SQL query, executing the instruction on a datastore, and returning the relevant result to the user. For example, the generative model may generate “SELECT*FROM employees WHERE YEAR(hire_date)=YEAR(CURRENT_DATE)” in response to the user request “Show me all employees who started this year.”

As used herein, the terms “about,” “similarly,” “substantially,” and “approximately” are defined as being largely but not necessarily wholly what is specified (and include wholly what is specified) as understood by one of ordinary skill in the art. In any disclosed embodiment, the term “about,” “similarly,” “substantially,” or “approximately” may be substituted with “within [a percentage] of” what is specified, where the percentage includes 0.1 percent, 1 percent, 5 percent, and 10 percent, etc.

As used herein, when an action is “based on” something, this means the action is based at least in part on at least a part of the something.

### VIII. ILLUSTRATIVE SYSTEMS

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will need the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 17 is a block diagram 1700 illustrating an example pattern of an IaaS architecture, according to at least one embodiment. Service operators 1702 can be communicatively coupled to a secure host tenancy 1704 that can include a virtual cloud network (VCN) 1706 and a secure host subnet 1708. In some examples, the service operators 1702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1706 and/or the Internet.

The VCN 1706 can include a local peering gateway (LPG) 1710 that can be communicatively coupled to a secure shell (SSH) VCN 1712 via an LPG 1710 contained in the SSH VCN 1712. The SSH VCN 1712 can include an SSH subnet 1714, and the SSH VCN 1712 can be communicatively coupled to a control plane VCN 1716 via the LPG 1710 contained in the control plane VCN 1716. Also, the SSH VCN 1712 can be communicatively coupled to a data plane VCN 1718 via an LPG 1710. The control plane VCN 1716 and the data plane VCN 1718 can be contained in a service tenancy 1719 that can be owned and/or operated by the IaaS provider.

The control plane VCN 1716 can include a control plane demilitarized zone (DMZ) tier 1720 that acts as a perimeter network (e.g., portions of a corporate network between the corporate intranet and external networks). The DMZ-based servers may have restricted responsibilities and help keep breaches contained. Additionally, the DMZ tier 1720 can include one or more load balancer (LB) subnet(s) 1722, a control plane app tier 1724 that can include app subnet(s) 1726, a control plane data tier 1728 that can include database (DB) subnet(s) 1730 (e.g., frontend DB subnet(s) and/or backend DB subnet(s)). The LB subnet(s) 1722 contained in the control plane DMZ tier 1720 can be communicatively coupled to the app subnet(s) 1726 contained in the control plane app tier 1724 and an Internet gateway 1734 that can be contained in the control plane VCN 1716, and the app subnet(s) 1726 can be communicatively coupled to the DB subnet(s) 1730 contained in the control plane data tier 1728 and a service gateway 1736 and a network address translation (NAT) gateway 1738. The control plane VCN 1716 can include the service gateway 1736 and the NAT gateway 1738.

The control plane VCN 1716 can include a data plane mirror app tier 1740 that can include app subnet(s) 1726. The app subnet(s) 1726 contained in the data plane mirror app tier 1740 can include a virtual network interface controller (VNIC) 1742 that can execute a compute instance 1744. The compute instance 1744 can communicatively couple the app subnet(s) 1726 of the data plane mirror app tier 1740 to app subnet(s) 1726 that can be contained in a data plane app tier 1746.

The data plane VCN 1718 can include the data plane app tier 1746, a data plane DMZ tier 1748, and a data plane data tier 1750. The data plane DMZ tier 1748 can include LB subnet(s) 1722 that can be communicatively coupled to the app subnet(s) 1726 of the data plane app tier 1746 and the Internet gateway 1734 of the data plane VCN 1718. The app subnet(s) 1726 can be communicatively coupled to the service gateway 1736 of the data plane VCN 1718 and the NAT gateway 1738 of the data plane VCN 1718. The data plane data tier 1750 can also include the DB subnet(s) 1730 that can be communicatively coupled to the app subnet(s) 1726 of the data plane app tier 1746.

The Internet gateway 1734 of the control plane VCN 1716 and of the data plane VCN 1718 can be communicatively coupled to a metadata management service 1752 that can be communicatively coupled to public Internet 1754. Public Internet 1754 can be communicatively coupled to the NAT gateway 1738 of the control plane VCN 1716 and of the data plane VCN 1718. The service gateway 1736 of the control plane VCN 1716 and of the data plane VCN 1718 can be communicatively coupled to cloud services 1756.

In some examples, the service gateway 1736 of the control plane VCN 1716 or of the data plane VCN 1718 can make application programming interface (API) calls to cloud services 1756 without going through public Internet 1754. The API calls to cloud services 1756 from the service gateway 1736 can be one-way: the service gateway 1736 can make API calls to cloud services 1756, and cloud services 1756 can send requested data to the service gateway 1736. But, cloud services 1756 may not initiate API calls to the service gateway 1736.

In some examples, the secure host tenancy 1704 can be directly connected to the service tenancy 1719, which may be otherwise isolated. The secure host subnet 1708 can communicate with the SSH subnet 1714 through an LPG 1710 that may enable two-way communication over an otherwise isolated system. Connecting the secure host subnet 1708 to the SSH subnet 1714 may give the secure host subnet 1708 access to other entities within the service tenancy 1719.

The control plane VCN 1716 may allow users of the service tenancy 1719 to set up or otherwise provision desired resources. Desired resources provisioned in the control plane VCN 1716 may be deployed or otherwise used in the data plane VCN 1718. In some examples, the control plane VCN 1716 can be isolated from the data plane VCN 1718, and the data plane mirror app tier 1740 of the control plane VCN 1716 can communicate with the data plane app tier 1746 of the data plane VCN 1718 via VNICs 1742 that can be contained in the data plane mirror app tier 1740 and the data plane app tier 1746.

In some examples, users of the system, or customers, can make requests, for example create, read, update, or delete (CRUD) operations, through public Internet 1754 that can communicate the requests to the metadata management service 1752. The metadata management service 1752 can communicate the request to the control plane VCN 1716 through the Internet gateway 1734. The request can be received by the LB subnet(s) 1722 contained in the control plane DMZ tier 1720. The LB subnet(s) 1722 may determine that the request is valid, and in response to this determination, the LB subnet(s) 1722 can transmit the request to app subnet(s) 1726 contained in the control plane app tier 1724. If the request is validated and needs a call to public Internet 1754, the call to public Internet 1754 may be transmitted to the NAT gateway 1738 that can make the call to public Internet 1754. Metadata that may be desired to be stored by the request can be stored in the DB subnet(s) 1730.

In some examples, the data plane mirror app tier 1740 can facilitate direct communication between the control plane VCN 1716 and the data plane VCN 1718. For example, changes, updates, or other suitable modifications to configuration may be desired to be applied to the resources contained in the data plane VCN 1718. Via a VNIC 1742, the control plane VCN 1716 can directly communicate with, and can thereby execute the changes, updates, or other suitable modifications to configuration to, resources contained in the data plane VCN 1718.

In some embodiments, the control plane VCN 1716 and the data plane VCN 1718 can be contained in the service tenancy 1719. In this case, the user, or the customer, of the system may not own or operate either the control plane VCN 1716 or the data plane VCN 1718. Instead, the IaaS provider may own or operate the control plane VCN 1716 and the data plane VCN 1718, both of which may be contained in the service tenancy 1719. This embodiment can enable isolation of networks that may prevent users or customers from interacting with other users', or other customers', resources. Also, this embodiment may allow users or customers of the system to store databases privately without needing to rely on public Internet 1754, which may not have a desired level of threat prevention, for storage.

In other embodiments, the LB subnet(s) 1722 contained in the control plane VCN 1716 can be configured to receive a signal from the service gateway 1736. In this embodiment, the control plane VCN 1716 and the data plane VCN 1718 may be configured to be called by a customer of the IaaS provider without calling public Internet 1754. Customers of the IaaS provider may desire this embodiment since database(s) that the customers use may be controlled by the IaaS provider and may be stored on the service tenancy 1719, which may be isolated from public Internet 1754.

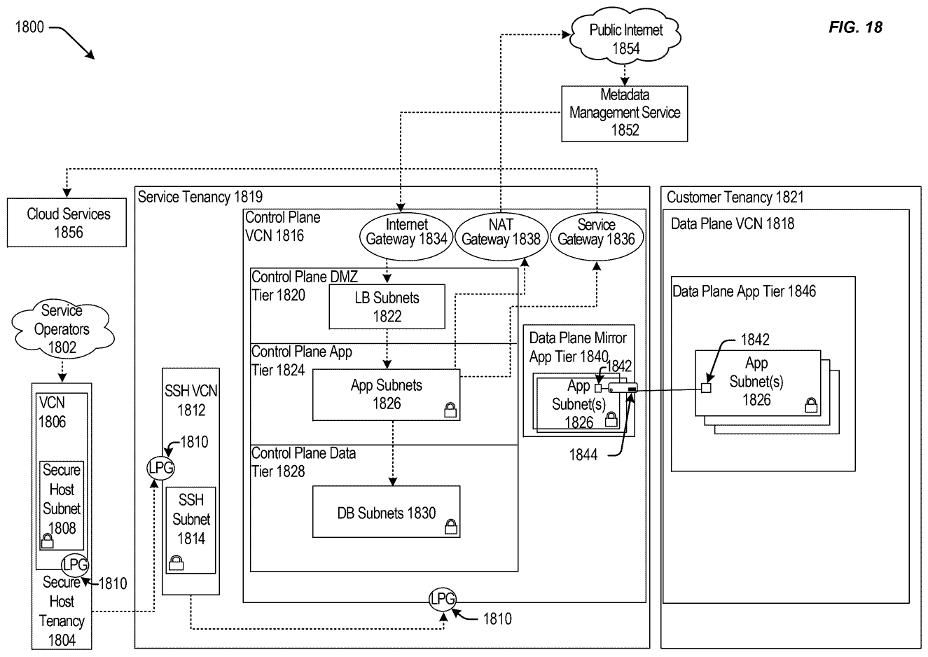

FIG. 18 is a block diagram 1800 illustrating another example pattern of an IaaS architecture, according to at least one embodiment. Service operators 1802 (e.g., service operators 1702 of FIG. 17) can be communicatively coupled to a secure host tenancy 1804 (e.g., the secure host tenancy 1704 of FIG. 17) that can include a virtual cloud network (VCN) 1806 (e.g., the VCN 1706 of FIG. 17) and a secure host subnet 1808 (e.g., the secure host subnet 1708 of FIG. 17). The VCN 1806 can include a local peering gateway (LPG) 1810 (e.g., the LPG 1710 of FIG. 17) that can be communicatively coupled to a secure shell (SSH) VCN 1812 (e.g., the SSH VCN 1712 of FIG. 17) via an LPG 1710 contained in the SSH VCN 1812. The SSH VCN 1812 can include an SSH subnet 1814 (e.g., the SSH subnet 1714 of FIG. 17), and the SSH VCN 1812 can be communicatively coupled to a control plane VCN 1816 (e.g., the control plane VCN 1716 of FIG. 17) via an LPG 1810 contained in the control plane VCN 1816. The control plane VCN 1816 can be contained in a service tenancy 1819 (e.g., the service tenancy 1719 of FIG. 17), and the data plane VCN 1818 (e.g., the data plane VCN 1718 of FIG. 17) can be contained in a customer tenancy 1821 that may be owned or operated by users, or customers, of the system.

The control plane VCN 1816 can include a control plane DMZ tier 1820 (e.g., the control plane DMZ tier 1720 of FIG. 17) that can include LB subnet(s) 1822 (e.g., LB subnet(s) 1722 of FIG. 17), a control plane app tier 1824 (e.g., the control plane app tier 1724 of FIG. 17) that can include app subnet(s) 1826 (e.g., app subnet(s) 1726 of FIG. 17), a control plane data tier 1828 (e.g., the control plane data tier 1728 of FIG. 17) that can include database (DB) subnet(s) 1830 (e.g., similar to DB subnet(s) 1730 of FIG. 17). The LB subnet(s) 1822 contained in the control plane DMZ tier 1820 can be communicatively coupled to the app subnet(s) 1826 contained in the control plane app tier 1824 and an Internet gateway 1834 (e.g., the Internet gateway 1734 of FIG. 17) that can be contained in the control plane VCN 1816, and the app subnet(s) 1826 can be communicatively coupled to the DB subnet(s) 1830 contained in the control plane data tier 1828 and a service gateway 1836 (e.g., the service gateway 1736 of FIG. 17) and a network address translation (NAT) gateway 1838 (e.g., the NAT gateway 1738 of FIG. 17). The control plane VCN 1816 can include the service gateway 1836 and the NAT gateway 1838.

The control plane VCN 1816 can include a data plane mirror app tier 1840 (e.g., the data plane mirror app tier 1740 of FIG. 17) that can include app subnet(s) 1826. The app subnet(s) 1826 contained in the data plane mirror app tier 1840 can include a virtual network interface controller (VNIC) 1842 (e.g., the VNIC of 1742) that can execute a compute instance 1844 (e.g., similar to the compute instance 1744 of FIG. 17). The compute instance 1844 can facilitate communication between the app subnet(s) 1826 of the data plane mirror app tier 1840 and the app subnet(s) 1826 that can be contained in a data plane app tier 1846 (e.g., the data plane app tier 1746 of FIG. 17) via the VNIC 1842 contained in the data plane mirror app tier 1840 and the VNIC 1842 contained in the data plane app tier 1846.

The Internet gateway 1834 contained in the control plane VCN 1816 can be communicatively coupled to a metadata management service 1852 (e.g., the metadata management service 1752 of FIG. 17) that can be communicatively coupled to public Internet 1854 (e.g., public Internet 1754 of FIG. 17). Public Internet 1854 can be communicatively coupled to the NAT gateway 1838 contained in the control plane VCN 1816. The service gateway 1836 contained in the control plane VCN 1816 can be communicatively coupled to cloud services 1856 (e.g., cloud services 1756 of FIG. 17).

In some examples, the data plane VCN 1818 can be contained in the customer tenancy 1821. In this case, the IaaS provider may provide the control plane VCN 1816 for each customer, and the IaaS provider may, for each customer, set up a unique compute instance 1844 that is contained in the service tenancy 1819. Each compute instance 1844 may allow communication between the control plane VCN 1816, contained in the service tenancy 1819, and the data plane VCN 1818 that is contained in the customer tenancy 1821. The compute instance 1844 may allow resources, that are provisioned in the control plane VCN 1816 that is contained in the service tenancy 1819, to be deployed or otherwise used in the data plane VCN 1818 that is contained in the customer tenancy 1821.

In other examples, the customer of the IaaS provider may have databases that live in the customer tenancy 1821. In this example, the control plane VCN 1816 can include the data plane mirror app tier 1840 that can include app subnet(s) 1826. The data plane mirror app tier 1840 can reside in the data plane VCN 1818, but the data plane mirror app tier 1840 may not live in the data plane VCN 1818. That is, the data plane mirror app tier 1840 may have access to the customer tenancy 1821, but the data plane mirror app tier 1840 may not exist in the data plane VCN 1818 or be owned or operated by the customer of the IaaS provider. The data plane mirror app tier 1840 may be configured to make calls to the data plane VCN 1818 but may not be configured to make calls to any entity contained in the control plane VCN 1816. The customer may desire to deploy or otherwise use resources in the data plane VCN 1818 that are provisioned in the control plane VCN 1816, and the data plane mirror app tier 1840 can facilitate the desired deployment, or other usage of resources, of the customer.

In some embodiments, the customer of the IaaS provider can apply filters to the data plane VCN 1818. In this embodiment, the customer can determine what the data plane VCN 1818 can access, and the customer may restrict access to public Internet 1854 from the data plane VCN 1818. The IaaS provider may not be able to apply filters or otherwise control access of the data plane VCN 1818 to any outside networks or databases. Applying filters and controls by the customer onto the data plane VCN 1818, contained in the customer tenancy 1821, can help isolate the data plane VCN 1818 from other customers and from public Internet 1854.

In some embodiments, cloud services 1856 can be called by the service gateway 1836 to access services that may not exist on public Internet 1854, on the control plane VCN 1816, or on the data plane VCN 1818. The connection between cloud services 1856 and the control plane VCN 1816 or the data plane VCN 1818 may not be live or continuous. Cloud services 1856 may exist on a different network owned or operated by the IaaS provider. Cloud services 1856 may be configured to receive calls from the service gateway 1836 and may be configured to not receive calls from public Internet 1854. Some cloud services 1856 may be isolated from other cloud services 1856, and the control plane VCN 1816 may be isolated from cloud services 1856 that may not be in the same region as the control plane VCN 1816. For example, the control plane VCN 1816 may be located in “Region 1,” and cloud service “Deployment 17,” may be located in Region 1 and in “Region 2.” If a call to Deployment 17 is made by the service gateway 1836 contained in the control plane VCN 1816 located in Region 1, the call may be transmitted to Deployment 17 in Region 1. In this example, the control plane VCN 1816, or Deployment 17 in Region 1, may not be communicatively coupled to, or otherwise in communication with, Deployment 17 in Region 2.

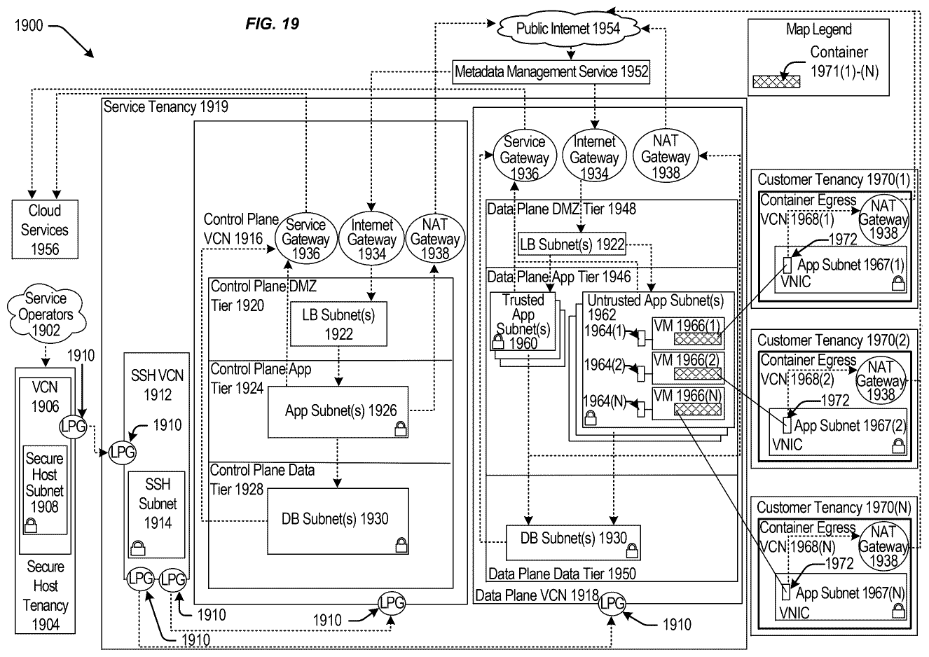

FIG. 19 is a block diagram 1900 illustrating another example pattern of an IaaS architecture, according to at least one embodiment. Service operators 1902 (e.g., service operators 1702 of FIG. 17) can be communicatively coupled to a secure host tenancy 1904 (e.g., the secure host tenancy 1704 of FIG. 17) that can include a virtual cloud network (VCN) 1906 (e.g., the VCN 1706 of FIG. 17) and a secure host subnet 1908 (e.g., the secure host subnet 1708 of FIG. 17). The VCN 1906 can include an LPG 1910 (e.g., the LPG 1710 of FIG. 17) that can be communicatively coupled to an SSH VCN 1912 (e.g., the SSH VCN 1712 of FIG. 17) via an LPG 1910 contained in the SSH VCN 1912. The SSH VCN 1912 can include an SSH subnet 1914 (e.g., the SSH subnet 1714 of FIG. 17), and the SSH VCN 1912 can be communicatively coupled to a control plane VCN 1916 (e.g., the control plane VCN 1716 of FIG. 17) via an LPG 1910 contained in the control plane VCN 1916 and to a data plane VCN 1918 (e.g., the data plane 1718 of FIG. 17) via an LPG 1910 contained in the data plane VCN 1918. The control plane VCN 1916 and the data plane VCN 1918 can be contained in a service tenancy 1919 (e.g., the service tenancy 1719 of FIG. 17).

The control plane VCN 1916 can include a control plane DMZ tier 1920 (e.g., the control plane DMZ tier 1720 of FIG. 17) that can include load balancer (LB) subnet(s) 1922 (e.g., LB subnet(s) 1722 of FIG. 17), a control plane app tier 1924 (e.g., the control plane app tier 1724 of FIG. 17) that can include app subnet(s) 1926 (e.g., similar to app subnet(s) 1726 of FIG. 17), a control plane data tier 1928 (e.g., the control plane data tier 1728 of FIG. 17) that can include DB subnet(s) 1930. The LB subnet(s) 1922 contained in the control plane DMZ tier 1920 can be communicatively coupled to the app subnet(s) 1926 contained in the control plane app tier 1924 and to an Internet gateway 1934 (e.g., the Internet gateway 1734 of FIG. 17) that can be contained in the control plane VCN 1916, and the app subnet(s) 1926 can be communicatively coupled to the DB subnet(s) 1930 contained in the control plane data tier 1928 and to a service gateway 1936 (e.g., the service gateway of FIG. 17) and a network address translation (NAT) gateway 1938 (e.g., the NAT gateway 1738 of FIG. 17). The control plane VCN 1916 can include the service gateway 1936 and the NAT gateway 1938.

The data plane VCN 1918 can include a data plane app tier 1946 (e.g., the data plane app tier 1746 of FIG. 17), a data plane DMZ tier 1948 (e.g., the data plane DMZ tier 1748 of FIG. 17), and a data plane data tier 1950 (e.g., the data plane data tier 1750 of FIG. 17). The data plane DMZ tier 1948 can include LB subnet(s) 1922 that can be communicatively coupled to trusted app subnet(s) 1960 and untrusted app subnet(s) 1962 of the data plane app tier 1946 and the Internet gateway 1934 contained in the data plane VCN 1918. The trusted app subnet(s) 1960 can be communicatively coupled to the service gateway 1936 contained in the data plane VCN 1918, the NAT gateway 1938 contained in the data plane VCN 1918, and DB subnet(s) 1930 contained in the data plane data tier 1950. The untrusted app subnet(s) 1962 can be communicatively coupled to the service gateway 1936 contained in the data plane VCN 1918 and DB subnet(s) 1930 contained in the data plane data tier 1950. The data plane data tier 1950 can include DB subnet(s) 1930 that can be communicatively coupled to the service gateway 1936 contained in the data plane VCN 1918.

The untrusted app subnet(s) 1962 can include one or more primary VNICs 1964(1)-(N) that can be communicatively coupled to tenant virtual machines (VMs) 1966(1)-(N). Each tenant VM 1966(1)-(N) can be communicatively coupled to a respective app subnet 1967(1)-(N) that can be contained in respective container egress VCNs 1968(1)-(N) that can be contained in respective customer tenancies 1970(1)-(N). Respective secondary VNICs 1972(1)-(N) can facilitate communication between the untrusted app subnet(s) 1962 contained in the data plane VCN 1918 and the app subnet contained in the container egress VCNs 1968(1)-(N). Each container egress VCNs 1968(1)-(N) can include a NAT gateway 1938 that can be communicatively coupled to public Internet 1954 (e.g., public Internet 1754 of FIG. 17).

The Internet gateway 1934 contained in the control plane VCN 1916 and contained in the data plane VCN 1918 can be communicatively coupled to a metadata management service 1952 (e.g., the metadata management system 1752 of FIG. 17) that can be communicatively coupled to public Internet 1954. Public Internet 1954 can be communicatively coupled to the NAT gateway 1938 contained in the control plane VCN 1916 and contained in the data plane VCN 1918. The service gateway 1936 contained in the control plane VCN 1916 and contained in the data plane VCN 1918 can be communicatively coupled to cloud services 1956.

In some embodiments, the data plane VCN 1918 can be integrated with customer tenancies 1970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1946. Code to run the function may be executed in the VMs 1966(1)-(N), and the code may not be configured to run anywhere else on the data plane VCN 1918. Each VM 1966(1)-(N) may be connected to one customer tenancy 1970. Respective containers 1971(1)-(N) contained in the VMs 1966(1)-(N) may be configured to run the code. In this case, there can be a dual isolation (e.g., the containers 1971(1)-(N) running code, where the containers 1971(1)-(N) may be contained in at least the VM 1966(1)-(N) that are contained in the untrusted app subnet(s) 1962), which may help prevent incorrect or otherwise undesirable code from damaging the network of the IaaS provider or from damaging a network of a different customer. The containers 1971(1)-(N) may be communicatively coupled to the customer tenancy 1970 and may be configured to transmit or receive data from the customer tenancy 1970. The containers 1971(1)-(N) may not be configured to transmit or receive data from any other entity in the data plane VCN 1918. Upon completion of running the code, the IaaS provider may kill or otherwise dispose of the containers 1971(1)-(N).

In some embodiments, the trusted app subnet(s) 1960 may run code that may be owned or operated by the IaaS provider. In this embodiment, the trusted app subnet(s) 1960 may be communicatively coupled to the DB subnet(s) 1930 and be configured to execute CRUD operations in the DB subnet(s) 1930. The untrusted app subnet(s) 1962 may be communicatively coupled to the DB subnet(s) 1930, but in this embodiment, the untrusted app subnet(s) may be configured to execute read operations in the DB subnet(s) 1930. The containers 1971(1)-(N) that can be contained in the VM 1966(1)-(N) of each customer and that may run code from the customer may not be communicatively coupled with the DB subnet(s) 1930.

In other embodiments, the control plane VCN 1916 and the data plane VCN 1918 may not be directly communicatively coupled. In this embodiment, there may be no direct communication between the control plane VCN 1916 and the data plane VCN 1918. However, communication can occur indirectly through at least one method. An LPG 1910 may be established by the IaaS provider that can facilitate communication between the control plane VCN 1916 and the data plane VCN 1918. In another example, the control plane VCN 1916 or the data plane VCN 1918 can make a call to cloud services 1956 via the service gateway 1936. For example, a call to cloud services 1956 from the control plane VCN 1916 can include a request for a service that can communicate with the data plane VCN 1918.

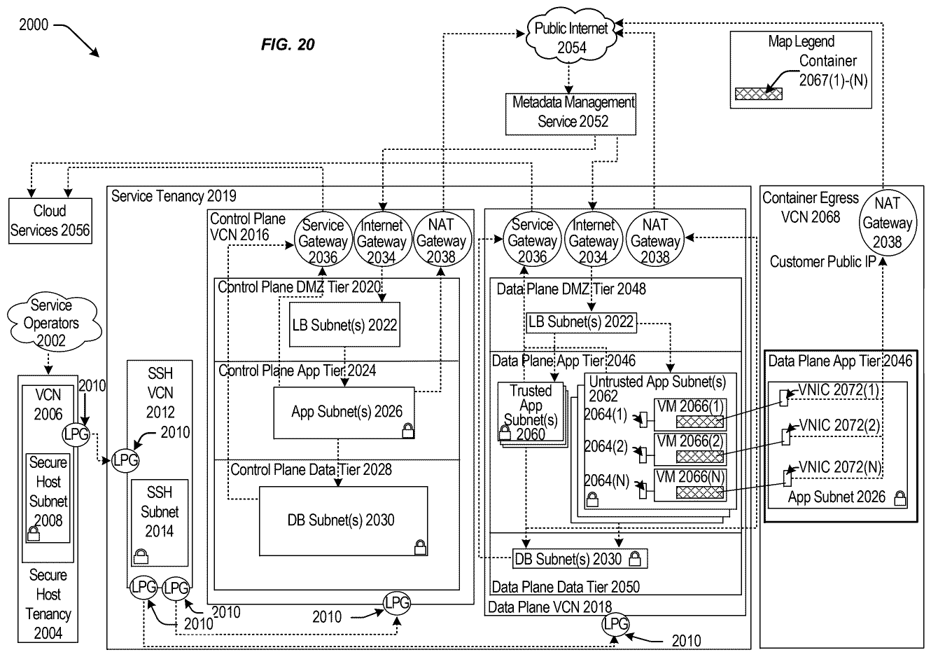

FIG. 20 is a block diagram 2000 illustrating another example pattern of an IaaS architecture, according to at least one embodiment. Service operators 2002 (e.g., service operators 1702 of FIG. 17) can be communicatively coupled to a secure host tenancy 2004 (e.g., the secure host tenancy 1704 of FIG. 17) that can include a virtual cloud network (VCN) 2006 (e.g., the VCN 1706 of FIG. 17) and a secure host subnet 2008 (e.g., the secure host subnet 1708 of FIG. 17). The VCN 2006 can include an LPG 2010 (e.g., the LPG 1710 of FIG. 17) that can be communicatively coupled to an SSH VCN 2012 (e.g., the SSH VCN 1712 of FIG. 17) via an LPG 2010 contained in the SSH VCN 2012. The SSH VCN 2012 can include an SSH subnet 2014 (e.g., the SSH subnet 1714 of FIG. 17), and the SSH VCN 2012 can be communicatively coupled to a control plane VCN 2016 (e.g., the control plane VCN 1716 of FIG. 17) via an LPG 2010 contained in the control plane VCN 2016 and to a data plane VCN 2018 (e.g., the data plane 1718 of FIG. 17) via an LPG 2010 contained in the data plane VCN 2018. The control plane VCN 2016 and the data plane VCN 2018 can be contained in a service tenancy 2019 (e.g., the service tenancy 1719 of FIG. 17).

The control plane VCN 2016 can include a control plane DMZ tier 2020 (e.g., the control plane DMZ tier 1720 of FIG. 17) that can include LB subnet(s) 2022 (e.g., LB subnet(s) 1722 of FIG. 17), a control plane app tier 2024 (e.g., the control plane app tier 1724 of FIG. 17) that can include app subnet(s) 2026 (e.g., app subnet(s) 1726 of FIG. 17), a control plane data tier 2028 (e.g., the control plane data tier 1728 of FIG. 17) that can include DB subnet(s) 2030 (e.g., DB subnet(s) 1930 of FIG. 19). The LB subnet(s) 2022 contained in the control plane DMZ tier 2020 can be communicatively coupled to the app subnet(s) 2026 contained in the control plane app tier 2024 and to an Internet gateway 2034 (e.g., the Internet gateway 1734 of FIG. 17) that can be contained in the control plane VCN 2016, and the app subnet(s) 2026 can be communicatively coupled to the DB subnet(s) 2030 contained in the control plane data tier 2028 and to a service gateway 2036 (e.g., the service gateway of FIG. 17) and a network address translation (NAT) gateway 2038 (e.g., the NAT gateway 1738 of FIG. 17). The control plane VCN 2016 can include the service gateway 2036 and the NAT gateway 2038.

The data plane VCN 2018 can include a data plane app tier 2046 (e.g., the data plane app tier 1746 of FIG. 17), a data plane DMZ tier 2048 (e.g., the data plane DMZ tier 1748 of FIG. 17), and a data plane data tier 2050 (e.g., the data plane data tier 1750 of FIG. 17). The data plane DMZ tier 2048 can include LB subnet(s) 2022 that can be communicatively coupled to trusted app subnet(s) 2060 (e.g., trusted app subnet(s) 1960 of FIG. 19) and untrusted app subnet(s) 2062 (e.g., untrusted app subnet(s) 1962 of FIG. 19) of the data plane app tier 2046 and the Internet gateway 2034 contained in the data plane VCN 2018. The trusted app subnet(s) 2060 can be communicatively coupled to the service gateway 2036 contained in the data plane VCN 2018, the NAT gateway 2038 contained in the data plane VCN 2018, and DB subnet(s) 2030 contained in the data plane data tier 2050. The untrusted app subnet(s) 2062 can be communicatively coupled to the service gateway 2036 contained in the data plane VCN 2018 and DB subnet(s) 2030 contained in the data plane data tier 2050. The data plane data tier 2050 can include DB subnet(s) 2030 that can be communicatively coupled to the service gateway 2036 contained in the data plane VCN 2018.

The untrusted app subnet(s) 2062 can include primary VNICs 2064(1)-(N) that can be communicatively coupled to tenant virtual machines (VMs) 2066(1)-(N) residing within the untrusted app subnet(s) 2062. Each tenant VM 2066(1)-(N) can run code in a respective container 2067(1)-(N), and be communicatively coupled to an app subnet 2026 that can be contained in a data plane app tier 2046 that can be contained in a container egress VCN 2068. Respective secondary VNICs 2072(1)-(N) can facilitate communication between the untrusted app subnet(s) 2062 contained in the data plane VCN 2018 and the app subnet contained in the container egress VCN 2068. The container egress VCN can include a NAT gateway 2038 that can be communicatively coupled to public Internet 2054 (e.g., public Internet 1754 of FIG. 17).

The Internet gateway 2034 contained in the control plane VCN 2016 and contained in the data plane VCN 2018 can be communicatively coupled to a metadata management service 2052 (e.g., the metadata management system 1752 of FIG. 17) that can be communicatively coupled to public Internet 2054. Public Internet 2054 can be communicatively coupled to the NAT gateway 2038 contained in the control plane VCN 2016 and contained in the data plane VCN 2018. The service gateway 2036 contained in the control plane VCN 2016 and contained in the data plane VCN 2018 can be communicatively coupled to cloud services 2056.

In some examples, the pattern illustrated by the architecture of block diagram 2000 of FIG. 20 may be considered an exception to the pattern illustrated by the architecture of block diagram 1900 of FIG. 19 and may be desirable for a customer of the IaaS provider if the IaaS provider cannot directly communicate with the customer (e.g., a disconnected region). The respective containers 2067(1)-(N) that are contained in the VMs 2066(1)-(N) for each customer can be accessed in real-time by the customer. The containers 2067(1)-(N) may be configured to make calls to respective secondary VNICs 2072(1)-(N) contained in app subnet(s) 2026 of the data plane app tier 2046 that can be contained in the container egress VCN 2068. The secondary VNICs 2072(1)-(N) can transmit the calls to the NAT gateway 2038 that may transmit the calls to public Internet 2054. In this example, the containers 2067(1)-(N) that can be accessed in real-time by the customer can be isolated from the control plane VCN 2016 and can be isolated from other entities contained in the data plane VCN 2018. The containers 2067(1)-(N) may also be isolated from resources from other customers.

In other examples, the customer can use the containers 2067(1)-(N) to call cloud services 2056. In this example, the customer may run code in the containers 2067(1)-(N) that requests a service from cloud services 2056. The containers 2067(1)-(N) can transmit this request to the secondary VNICs 2072(1)-(N) that can transmit the request to the NAT gateway that can transmit the request to public Internet 2054. Public Internet 2054 can transmit the request to LB subnet(s) 2022 contained in the control plane VCN 2016 via the Internet gateway 2034. In response to determining the request is valid, the LB subnet(s) can transmit the request to app subnet(s) 2026 that can transmit the request to cloud services 2056 via the service gateway 2036.

It should be appreciated that IaaS architectures 1700, 1800, 1900, 2000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

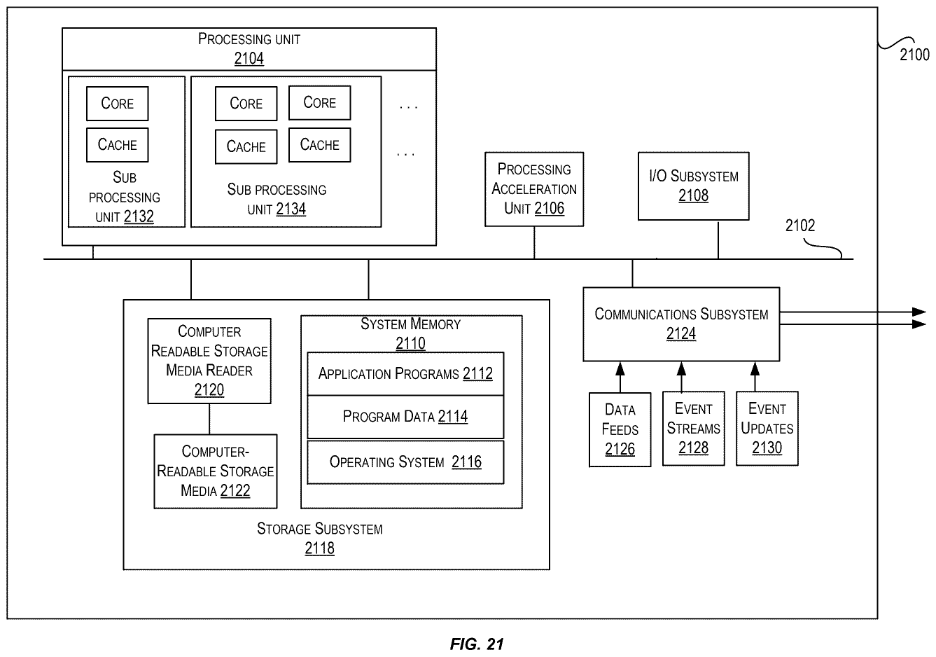

FIG. 21 illustrates an example computer system 2100, in which various embodiments may be implemented. The system 2100 may be used to implement any of the computer systems described above. As shown in the figure, computer system 2100 includes a processing unit 2104 that communicates with a number of peripheral subsystems via a bus subsystem 2102. These peripheral subsystems may include a processing acceleration unit 2106, an I/O subsystem 2108, a storage subsystem 2118 and a communications subsystem 2124. Storage subsystem 2118 includes tangible computer-readable storage media 2122 and a system memory 2110.

Bus subsystem 2102 provides a mechanism for letting the various components and subsystems of computer system 2100 communicate with each other as intended. Although bus subsystem 2102 is shown schematically as a single bus, alternative embodiments of the bus subsystem may utilize multiple buses. Bus subsystem 2102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 2104, which can be implemented as one or more integrated circuits (e.g., a conventional microprocessor or microcontroller), controls the operation of computer system 2100. One or more processors may be included in processing unit 2104. These processors may include single core or multicore processors. In certain embodiments, processing unit 2104 may be implemented as one or more independent processing units 2132 and/or 2134 with single or multicore processors included in each processing unit. In other embodiments, processing unit 2104 may also be implemented as a quad-core processing unit formed by integrating two dual-core processors into a single chip.

In various embodiments, processing unit 2104 can execute a variety of programs in response to program code and can maintain multiple concurrently executing programs or processes. At any given time, some or all of the program code to be executed can be resident in processor(s) 2104 and/or in storage subsystem 2118. Through suitable programming, processor(s) 2104 can provide various functionalities described above. Computer system 2100 may additionally include a processing acceleration unit 2106, which can include a digital signal processor (DSP), a special-purpose processor, and/or the like.

I/O subsystem 2108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 2100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 2100 may comprise a storage subsystem 2118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 2104 provide the functionality described above. Storage subsystem 2118 may also provide a repository for storing data used in accordance with the present disclosure.

As depicted in the example in FIG. 21, storage subsystem 2118 can include various components including a system memory 2110, computer-readable storage media 2122, and a computer readable storage media reader 2120. System memory 2110 may store program instructions that are loadable and executable by processing unit 2104. System memory 2110 may also store data that is used during the execution of the instructions and/or data that is generated during the execution of the program instructions. Various different kinds of programs may be loaded into system memory 2110 including but not limited to client applications, Web browsers, mid-tier applications, relational database management systems (RDBMS), virtual machines, containers, etc.

System memory 2110 may also store an operating system 2116. Examples of operating system 2116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 2100 executes one or more virtual machines, the virtual machines along with their guest operating systems (GOSs) may be loaded into system memory 2110 and executed by one or more processors or cores of processing unit 2104.

System memory 2110 can come in different configurations depending upon the type of computer system 2100. For example, system memory 2110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 2110 may include a basic input/output system (BIOS) containing basic routines that help to transfer information between elements within computer system 2100, such as during start-up.

Computer-readable storage media 2122 may represent remote, local, fixed, and/or removable storage devices plus storage media for temporarily and/or more permanently containing, storing, computer-readable information for use by computer system 2100 including instructions executable by processing unit 2104 of computer system 2100.

Computer-readable storage media 2122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 2122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 2122 may include, but is not limited to, Zip® drives, flash memory cards, universal serial bus (USB) flash drives, secure digital (SD) cards, DVD disks, digital video tape, and the like. Computer-readable storage media 2122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 2100.

Machine-readable instructions executable by one or more processors or cores of processing unit 2104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 2124 provides an interface to other computer systems and networks. Communications subsystem 2124 serves as an interface for receiving data from and transmitting data to other systems from computer system 2100. For example, communications subsystem 2124 may enable computer system 2100 to connect to one or more devices via the Internet. In some embodiments communications subsystem 2124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 2124 can provide wired network connectivity (e.g., Ethernet) in addition to or instead of a wireless interface.

In some embodiments, communications subsystem 2124 may also receive input communication in the form of structured and/or unstructured data feeds 2126, event streams 2128, event updates 2130, and the like on behalf of one or more users who may use computer system 2100.

By way of example, communications subsystem 2124 may be configured to receive data feeds 2126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 2124 may also be configured to receive data in the form of continuous data streams, which may include event streams 2128 of real-time events and/or event updates 2130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 2124 may also be configured to output the structured and/or unstructured data feeds 2126, event streams 2128, event updates 2130, and the like to one or more databases that may be in communication with one or more streaming data source computers coupled to computer system 2100.

Computer system 2100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 2100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments need at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
accessing a training data set comprising training examples, wherein each of the training examples comprises a prompt that includes a natural language utterance and a database schema;
augmenting each of the training examples one or more times, wherein the augmenting each of the training examples includes:
generating an augmentation prompt that includes a perturbation instruction instructing a generative model to modify the prompt of a training example of the training data set in accordance with one or more perturbations selected from a set of categories of perturbations,
generating, by the generative model, an augmented training example based on the augmentation prompt and the training example, wherein generating the augmented training example comprises perturbing the natural language utterance, the database schema, or both, of the prompt of the training example in accordance with the one or more perturbations, and wherein the perturbing generates a variant prompt comprising a variant of the natural language utterance, the database schema, or both, and
adding the augmented training example comprising the variant prompt to an augmented training data set; and
fine-tuning, based on the augmented training examples from the augmented training data set, a pre-trained generative model to generate a fine-tuned generative model.

2. The computer-implemented method of claim 1, further comprising:
accessing a test data set comprising test examples, wherein each of the test examples comprises a prompt that includes a natural language utterance and a database schema;
augmenting each of the test examples one or more times, wherein augmenting each of the test examples includes:
generating an augmentation prompt that includes a perturbation instruction instructing the generative model to modify the prompt of a test example of the test data set in accordance with one or more perturbations selected from a set of categories of perturbations,
generating, by the generative model, an augmented test example based on the augmentation prompt and the test example, wherein generating the augmented test example comprises perturbing the natural language utterance, the database schema, or both, of the prompt of the test example in accordance with the one or more perturbations, and wherein the perturbing generates a variant prompt comprising a variant of the natural language utterance, the database schema, or both, and
adding the augmented test example comprising the variant prompt to an augmented test data set; and
evaluating, based on the augmented test examples from the augmented test data set, performance of the fine-tuned generative model.

3. The computer-implemented method of claim 1, further comprising accessing an original set of training data for the pre-trained generative model, wherein the pre-trained generative model is fine-tuned based on batch balancing examples from the original set of training data and the augmented training examples from the augmented training data set.

4. The computer-implemented method of claim 1, further comprising filtering the augmented training examples from the augmented training data set to obtain a filtered augmented training data set comprising filtered augmented training examples, wherein the filtering removes invalid augmented training examples from the augmented training data set, and wherein the pre-trained generative model is fine-tuned based on the filtered augmented training examples from the filtered augmented training data set to generate the fine-tuned generative model.

5. The computer-implemented method of claim 1, wherein the one or more perturbations comprise a paraphrase perturbation, a change in order perturbation, a punctuation perturbation, a change in length perturbation, a direct form change perturbation, a keyword replacement perturbation, or any combination thereof.

6. The computer-implemented method of claim 1, further comprising:
receiving a natural language (NL) utterance from a user;
generating, by the fine-tuned generative model, a programming language instruction based on the NL utterance;
executing the programming language instruction on a datastore to obtain a result; and
providing the result to the user.

7. The computer-implemented method of claim 1, wherein the pre-trained generative model is pre-trained for a task of translating natural language utterances to structured query language instructions.

8. A system comprising:
one or more processors; and
one or more computer-readable media storing instructions which, when executed by the one or more processors, cause the system to perform operations comprising:
accessing a training data set comprising training examples, wherein each of the training examples comprises a prompt that includes a natural language utterance and a database schema;
augmenting each of the training examples one or more times, wherein augmenting each of the training examples includes:
generating, by a generative model, an augmented training example based on an augmentation prompt and a training example of the training data set, wherein generating the augmented training example comprises perturbing the natural language utterance, the database schema, or both, of the prompt of the training example in accordance with one or more perturbations, and wherein the perturbing generates a variant prompt comprising a variant of the natural language utterance, the database schema, or both, and
adding the augmented training example comprising the variant prompt to an augmented training data set; and
fine-tuning, based on the augmented training examples from the augmented training data set, a pre-trained generative model to generate a fine-tuned generative model.

9. The system of claim 8, wherein the operations further comprise:
accessing a test data set comprising test examples, wherein each of the test examples comprises a prompt that includes a natural language utterance and a database schema;
augmenting each of the test examples one or more times, wherein augmenting each of the test examples includes:
generating an augmentation prompt that includes a perturbation instruction instructing the generative model to modify the prompt of a test example of the test data set in accordance with one or more perturbations selected from a set of categories of perturbations,
generating, by the generative model, an augmented test example based on the augmentation prompt and the test example, wherein generating the augmented test example comprises perturbing the natural language utterance, the database schema, or both, of the prompt of the test example in accordance with the one or more perturbations, and wherein the perturbing generates a variant prompt comprising a variant of the natural language utterance, the database schema, or both, and
adding the augmented test example comprising the variant prompt to an augmented test data set; and
evaluating, based on the augmented test examples from the augmented test data set, performance of the fine-tuned generative model.

10. The system of claim 8, wherein the operations further comprise accessing an original set of training data for the pre-trained generative model, wherein the pre-trained generative model is fine-tuned based on batch balancing examples from the original set of training data and the augmented training examples from the augmented training data set.

11. The system of claim 8, wherein the operations further comprise filtering the augmented training examples from the augmented training data set to obtain a filtered augmented training data set comprising filtered augmented training examples, wherein the filtering removes invalid augmented training examples from the augmented training data set, and wherein the pre-trained generative model is fine-tuned based on the filtered augmented training examples from the filtered augmented training data set to generate the fine-tuned generative model.

12. The system of claim 8, wherein the one or more perturbations comprise a paraphrase perturbation, a change in order perturbation, a punctuation perturbation, a change in length perturbation, a direct form change perturbation, a keyword replacement perturbation, or any combination thereof.

13. The system of claim 8, wherein the operations further comprise:
receiving a natural language (NL) utterance from a user;
generating, by the fine-tuned generative model, a programming language instruction based on the NL utterance;
executing the programming language instruction on a datastore to obtain a result; and
providing the result to the user.

14. The system of claim 8, wherein the pre-trained generative model is pre-trained for a task of translating natural language utterances to structured query language instructions.

15. One or more non-transitory computer-readable media storing instructions which, when executed by one or more processors, cause the one or more processors to perform operations comprising:
accessing a training data set comprising training examples, wherein each of the training examples comprises a prompt that includes an instruction for translating a natural language utterance to a structured query language instruction, the natural language utterance, a database schema, and a business logic instruction;
augmenting each of the training examples one or more times, wherein the augmenting each of the training examples includes:
generating an augmentation prompt that includes a perturbation instruction instructing a generative model to modify the prompt of a training example of the training data set in accordance with one or more perturbations selected from a set of categories of perturbations,
generating, by the generative model, an augmented training example based on the augmentation prompt and the training example, wherein generating the augmented training example comprises perturbing the natural language utterance, the database schema, the business logic instruction, or any combination thereof of the prompt of the training example in accordance with the one or more perturbations, and wherein the perturbing generates and a variant prompt comprising a variant of the natural language utterance, the database schema, the business logic instruction, or any combination thereof, and
adding the augmented training example comprising the variant prompt to an augmented training data set; and
fine-tuning, based on the augmented training examples from the augmented training data set, a pre-trained generative model to generate a fine-tuned generative model, wherein the pre-trained generative model is pre-trained for a task of translating natural language utterances to structured query language instructions.

16. The one or more non-transitory computer-readable media of claim 15, wherein the operations further comprise:
accessing a test data set comprising test examples, wherein each of the test examples comprises a prompt that includes an instruction for translating a natural language utterance to a structured query language instruction, the natural language utterance, a database schema, and a business logic instruction;
augmenting each of the test examples one or more times, wherein augmenting each of the test examples includes:
generating an augmentation prompt that includes a perturbation instruction instructing the generative model to modify the prompt of a test example of the test data set in accordance with one or more perturbations selected from a set of categories of perturbations,
generating, by the generative model, an augmented test example based on the augmentation prompt and the test example, wherein generating the augmented test example comprises perturbing the natural language utterance, the database schema, the business logic instruction, or any combination thereof, of the prompt of the test example in accordance with the one or more perturbations, and wherein the perturbing generates a variant prompt comprising a variant of the natural language utterance, the database schema, or both, and
adding the augmented test example comprising the variant prompt to an augmented test data set; and
evaluating, based on the augmented test examples from the augmented test data set, performance of the fine-tuned generative model.

17. The one or more non-transitory computer-readable media of claim 15, wherein the operations further comprise accessing an original set of training data for the pre-trained generative model, wherein the pre-trained generative model is fine-tuned based on batch balancing examples from the original set of training data and the augmented training examples from the augmented training data set.

18. The one or more non-transitory computer-readable media of claim 15, wherein the operations further comprise filtering the augmented training examples from the augmented training data set to obtain a filtered augmented training data set comprising filtered augmented training examples, wherein the filtering removes invalid augmented training examples from the augmented training data set, and wherein the pre-trained generative model is fine-tuned based on the filtered augmented training examples from the filtered augmented training data set to generate the fine-tuned generative model.

19. The one or more non-transitory computer-readable media of claim 15, wherein the one or more perturbations comprise a paraphrase perturbation, a change in order perturbation, a punctuation perturbation, a change in length perturbation, a direct form change perturbation, a keyword replacement perturbation, or any combination thereof.

20. The one or more non-transitory computer-readable media of claim 15, wherein the operations further comprise:
receiving a natural language (NL) utterance from a user;
generating, by the fine-tuned generative model, a programming language instruction based on the NL utterance;
executing the programming language instruction on a datastore to obtain a result; and
providing the result to the user.
